(19) United States
(12) Patent Application Publication
(10) Pub. No.: US 2013/0335962 A1
(43) Pub. Date: Dec. 19, 2013

(54) LIGHTING ASSEMBLY HAVING A WAVEFORM REFLECTOR

(71) Applicants: PIXI LIGHTING LLC, Orange, CA (US); KENMOS TECHNOLOGY CO., LTD., Tainan City (TW)

(72) Inventors: YI-CHEN WU, TAINAN CITY (TW); CHIEN-FENG HUNG, TAINAN CITY (TW); CHIH-CHIEH KAO, TAIPEI (TW); JOHN ARAKI, TUSTIN, CA (US); I-CHUN CHEN, TAINAN CITY (TW)

(73) Assignees: KENMOS TECHNOLOGY CO., LTD., TAINAN CITY (TW); PIXI LIGHTING LLC, ORANGE, CA (US)

(21) Appl. No.: 13/841,725

(22) Filed: Mar. 15, 2013

Related U.S. Application Data
(60) Provisional application No. 61/732,142, filed on Nov. 30, 2012.
(60) Provisional application No. 61/745,314, filed on Dec. 21, 2012.

(30) Foreign Application Priority Data
Jun. 13, 2012 (TW) 101211386

(51) Int. Cl. F21V 7/00

(52) U.S. Cl. CPC F21V 7/00
USPC 362/235; 362/341

(57) ABSTRACT

The present disclosure relates to a light emitting diode (LED) light fixture including a frame, a light diffuser coupled to the frame, at least one LED array disposed adjacent at least one side wall of the frame and a waveform reflector panel having at least one two troughs and one crest disposed between the two troughs. The at least one LED array is disposed at an angle relative to the side wall side wall of the frame and the waveform reflector is positioned to receive and light generated by the LED array and to reflect the light through the light diffuser.

### CROSS REFERENCE TO RELATED APPLICATIONS

The present application claims benefit of Taiwan Patent Application No. 101211386 filed Jun. 13, 2012, entitled LAMP ILLUMINANT STRUCTURE, the entire content of which is hereby incorporated by reference. The present application also claims benefit of U.S. Provisional Application. No. 61/732,142 filed Nov. 30, 2012, entitled LIGHTING ASSEMBLY HAVING A WAVEFORM REFLECTOR, the entire content of which is hereby incorporated by reference. The present application also claims benefit of U.S. Provisional Application No. 61/745,314 filed Dec. 21, 2012, entitled LIGHTING ASSEMBLY HAVING A WAVEFORM REFLECTOR, the entire content of which is hereby incorporated by reference.

### BACKGROUND OF THE INVENTION

1. Field of the Invention

The present invention relates generally to lighting assemblies, and more particularly to a light emitting diode lighting assembly having a waveform reflector.

2. Description of the Related Art

For years, lighting systems, such as ceiling mounted lighting fixtures or luminaires, have made use of fluorescent lamps and/or incandescent lamps. In addition to the lamps, lighting systems typically include an assembly of components, such as ballasts and reflectors. Lighting devices that incorporate fluorescent lamps are the most commonly used commercial light sources due to their relatively high efficiency, diffuse light distribution characteristics, and long operating life. Lighting devices that incorporate light emitting diodes are emerging as an attractive alternative to fluorescent lamps, providing marked improvements in efficiency and operating life.

### SUMMARY OF THE INVENTION

The present application is directed to a light emitting diode (LED) light fixture that includes an array of LEDs positioned to emit light toward a waveform reflector. The waveform reflector includes two troughs and a crest disposed between the troughs.

One aspect of the disclosed technology relates to a lamp illuminant structure having a lamp box provided with a reflection panel in the chamber of the lamp box; wherein the reflection panel is a wavy reflection plane including two troughs and one crest located between two troughs, and wherein two luminous bodies are respectively arranged adjacent to the internal wall of two sides of the chamber and respectively adjacent to two troughs of the reflection panel; the two luminous bodies forming an angle from 0° to 90° with the chamber internal wall arranged as a perpendicular plane with the lamp box.

According to one feature of the lamp illuminant structure, the two luminous bodies form an angle from 30° to 60° with the chamber internal wall arranged as a perpendicular plane with the lamp box.

According to another feature of the lamp illuminant structure, a height difference between the luminous body and the crest of the reflection panel is from 0 to 10 mm.

In another embodiment, a height difference between the luminous body and the crest of the reflection panel is 0 mm.

According to another feature, the chamber internal wall of the box is integrated with a slope for the arrangement of the luminous body thereon. In one embodiment, the slope forms an angle from 30° to 60° with the chamber internal wall arranged as a perpendicular plane with the lamp box.

According to a further feature, the box is further provided with an optically-transmissive panel corresponding to the reflecting plane of the reflection panel. In one embodiment, the optically-transmissive panel comprises a diffusing panel. In another embodiment, the optically-transmissive panel comprises a micro-lens diffuser panel.

Another aspect of the disclosed technology relates to a light fixture that includes a frame, the frame including a plurality of side walls; an optically-transmissive panel coupled to the frame and disposed in a plane perpendicular to the side walls; a light emitting diode (LED) array disposed adjacent at least one of the side walls, the LED array being disposed at an angle of about 0° to 90° relative to the plane of the light diffuser; and a waveform reflector plate coupled to the frame and positioned to receive and light generated by the LED array and to reflect the light through the optically-transmissive panel.

According to one feature of the light fixture, the waveform reflector plate is configured to include a pair of troughs and a crest disposed between the troughs.

According to another feature, the crest is positioned at a distance of about 0 centimeters to about 5 centimeters from the optically-transmissive panel.

According to a further feature, the crest is positioned at a distance of about 3 centimeters to about 10 centimeters from the optically-transmissive panel.

According to a further feature, the frame includes a back panel coupled to the plurality of side walls.

According to yet another feature, the waveform reflector plate is coupled to a rigid supporting structure.

According to still another feature, the light diffuser comprises a micro-lens diffuser plate. The micro-lens diffuser plate may include a plurality of micro-lenses having a pitch of about 10 microns to about 100 microns.

According to another feature, the optically-transmissive panel comprises a light diffusing panel.

According to yet another feature, the optically-transmissive panel comprises a micro-lens diffuser plate. In one embodiment, the micro-lens diffuser plate includes a plurality of micro-lenses having a pitch of about 10 microns to about 100 microns.

According to a further feature, the crest is positioned at a height of about 1 centimeter to about 10 centimeters relative to the troughs.

According to yet another feature, the crest is laterally spaced about 120 millimeters to about 160 millimeters from the troughs.

According to still another feature, the waveform reflector plate includes a non-specular reflection surface.

According to a further feature, the light fixture includes a pair of LED arrays disposed adjacent opposite side walls of the frame.

According to yet another feature, the light fixture includes a pair of LED arrays disposed adjacent opposite side walls of the frame. In one embodiment, each of the side walls of the frame is integrated with an inner support wall for the arrangement of the pair of LED arrays.

According to a further feature, the frame has a length and a width at the plane perpendicular to the side walls, and the frame and the optically-transmissive panel cooperate to define a light-emission area of about 90% of the length by about 90% of the width.

According to yet another feature, the light fixture includes a first configuration of LEDs, and a second configuration of LEDs. In one embodiment, the light fixture includes power circuitry configured to power the first configuration of LEDs for a first time period and to power the second configuration of LEDs for a second time period equal to the first time period. In another embodiment, the light fixture includes power circuitry configured to alternatively power the first configuration of LEDs and the second configuration of LEDs over a cyclical time period including a first time period and a second time period.

According to one feature, the light fixture includes power circuitry disposed behind the waveform reflector plate, the power circuitry being configured to electrically couple the light emitting diode (LED) array to an external power supply. In one embodiment, the power circuitry is disposed behind the crest of the waveform reflector plate.

These and further features of the disclosed technology will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a sectional view of one exemplary embodiment of the disclosed technology;

FIG. 2 is a partial enlarged sectional view of the exemplary embodiment shown in FIG. 1;

FIG. 3 is an optical diagram of one exemplary embodiment of the disclosed technology where the angle that the luminous body projects on the trough of the reflection panel is 0° and the distance between the luminous body and the crest of the reflection panel is 0 mm;

FIG. 4 is an optical diagram one exemplary embodiment of the disclosed technology where the angle that the luminous body projects on the trough of the reflection panel is 0° and the distance between the luminous body and the crest of the reflection panel is 10 mm;

FIG. 5 is an optical diagram of one exemplary embodiment of the disclosed technology where the angle that the luminous body projects on the trough of the reflection panel is 0° and the distance between the luminous body and the crest of the reflection panel is 30 mm;

FIG. 6 is an optical diagram of one exemplary embodiment of the disclosed technology where the angle that the luminous body projects on the trough of the reflection panel is 0° and the distance between the luminous body and the crest of the reflection panel is 62 mm;

FIG. 7 is an optical diagram of one exemplary embodiment of the disclosed technology where the angle that the luminous body projects on the trough of the reflection panel is 30° and the distance between the luminous body and the crest of the reflection panel is 0 mm;

FIG. 8 is an optical diagram of one exemplary embodiment of the disclosed technology where the angle that the luminous body projects on the trough of the reflection panel is 45° and the distance between the luminous body and the crest of the reflection panel is 0 mm;

FIG. 9 is an optical diagram of one exemplary embodiment of the disclosed technology where the angle that the luminous body projects on the trough of the reflection panel is 60° and the distance between the luminous body and the crest of the reflection panel is 0 mm;

FIG. 10 is a diagrammatic illustration of a light fixture in accordance with one aspect of the disclosed technology in which the light fixture is substantially square;

FIG. 11 is a diagrammatic illustration of a light fixture in accordance with one aspect of the disclosed technology in which the light fixture is rectangular;

FIG. 12 is a diagrammatic illustration of a light fixture in accordance with one aspect of the disclosed technology;

FIG. 13 is an exploded perspective view of a portion of a light fixture in accordance with one aspect of the disclosed technology in which the light fixture is substantially square;

FIG. 14 is an exploded perspective view of a light fixture in accordance with one aspect of the disclosed technology in which the light fixture is rectangular;

FIG. 15 is a diagrammatic illustration of a light fixture having a waveform reflector panel in accordance with one aspect of the disclosed technology, in which power circuitry is positioned behind a crest of the reflector panel;

FIG. 16 is a diagrammatic illustration of a light fixture having a waveform reflector panel in accordance with one aspect of the disclosed technology, in which power circuitry is positioned behind troughs of the reflector panel;

FIG. 17 is a diagrammatic illustration of a portion of a frame housing power circuitry; and, a reflector panel in accordance with one aspect of the disclosed technology;

FIG. 18 is a diagrammatic illustration of a portion of a frame housing power circuitry; and a reflector panel in accordance with one aspect of the disclosed technology, illustrating various placements of the power circuitry within the frame;

FIG. 19 is a diagrammatic illustration of a portion of a light fixture frame in accordance with one aspect of the disclosed technology, in which a wiring conduit is at a corner of the frame;

FIG. 20 is a diagrammatic illustration of a portion of a light fixture frame in accordance with one aspect of the disclosed technology, illustrating a cover of the frame;

FIG. 21 is a diagrammatic illustration of a light fixture having a waveform reflector panel in accordance with one aspect of the disclosed technology;

FIG. 22 is a diagrammatic illustration of a light fixture having a waveform reflector panel in accordance with one aspect of the disclosed technology, in which a diffusing panel is utilized;

FIG. 23 is a diagrammatic illustration of a light fixture having a waveform reflector panel in accordance with one aspect of the disclosed technology, in which an array of LEDs is mounted on an inner support wall of the frame;

FIG. 24 is a front side perspective view of a light fixture having a waveform reflector panel in accordance with one aspect of the disclosed technology;

FIG. 25 is a diagrammatic illustration of a portion of a light fixture frame, partially exploded, in which the array of LEDs is affixed to an inner support wall of the frame, in accordance with one aspect of the disclosed technology;

FIG. 26 is an enlarged view of a portion of FIG. 25;

FIG. 27 is a diagrammatic illustration of a portion of a light fixture frame in accordance with one aspect of the disclosed technology, showing use of corner brackets and fasteners;

FIG. 28 is a diagrammatic illustration of a portion of a light fixture frame in accordance with one aspect of the disclosed technology, showing use of corner brackets and fasteners, FIG. 28 showing a larger portion of the frame than FIG. 27;

FIG. 29 is a diagrammatic illustration of a portion of a light fixture frame and waveform reflector panel in accordance with one aspect of the disclosed technology, illustrating installation of the corner brackets;

FIG. 30 is a diagrammatic illustration of a light fixture having a waveform reflector panel in accordance with one aspect of the disclosed technology, illustrating the use of a diffuser plate;

FIG. 31 is a diagrammatic illustration of a portion of a light fixture frame in accordance with one aspect of the disclosed technology;

FIG. 32 is a diagrammatic illustration of a portion of a light fixture frame in accordance with one aspect of the disclosed technology, showing an angled orientation of the LED array;

FIG. 33 is a diagrammatic illustration of a waveform cover for a light fixture in accordance with one aspect of the disclosed technology;

FIG. 34 is a diagrammatic illustration of the waveform cover of FIG. 33, in a section taken at A-A, in accordance with one aspect of the disclosed technology;

FIG. 35 is a diagrammatic illustration of the waveform cover of FIG. 33, in a section taken at B-B, in accordance with one aspect of the disclosed technology;

FIG. 36 is a diagrammatic illustration of a LED driving assembly in accordance with one aspect of the disclosed technology;

FIG. 37 is a diagrammatic illustration of an alternative LED driving assembly in accordance with one aspect of the disclosed technology;

FIG. 38 is a diagrammatic illustration of a LED array in accordance with one aspect of the disclosed technology;

FIG. 39 is a diagrammatic illustration of an alternative LED array in accordance with one aspect of the disclosed technology in which the LEDs are arranged in a two-strip bar;

FIG. 40 is a diagrammatic illustration of a LED array in accordance with one aspect of the disclosed technology in which there is an alternating arrangement of LEDs;

FIG. 41 is a front, side perspective view of the light fixture shown in FIGS. 33-35; and,

FIG. 42 is an exploded rear perspective view of the light fixture of FIGS. 33-35.

### DETAILED DESCRIPTION OF THE INVENTION

To illustrate aspects of the disclosed technology in a clear and concise manner, the drawings may not necessarily be to scale and certain features may be shown in somewhat schematic form.

The disclosed technology relates to a light emitting diode (LED) light fixture (also referred to as a lamp illuminant structure), including a waveform reflection panel (also referred to as a reflection panel, waveform reflection plate, reflection plate, wavy reflection plane, or a reflection plane) that includes two troughs and one crest disposed between the two troughs. In accordance with one exemplary embodiment, the light fixture includes two arrays of LEDs positioned at an angle with respect to the light fixture frame such that the LEDs are positioned to emit light toward the waveform reflection panel. The waveform reflection panel reflects light from the LEDs through a light emission area. As is discussed more fully below, the light fixture can include an optically-transmissive panel and/or a light diffuser through which light reflected by the waveform reflection panel passes.

One aspect of the disclosed technology relates to a lamp illuminant structure which aims at providing a lamp illuminant technique for a simple structure and producing a fine illuminating effect.

In accordance with one exemplary embodiment, the lamp illuminant structure includes a lamp box provided with a reflection panel in the chamber of the lamp box. The reflection panel is a wavy reflection plane that includes two troughs and one crest located between two troughs, and two luminous bodies are respectively arranged in the internal wall of two sides of the chamber and respectively adjacent to two troughs of the reflection panel. The respective projection of two luminous bodies on two troughs of the reflection panel can generate intensive interlaced bright light rays to project so as to achieve a fine illuminating effect.

As described below, a height difference between the luminous body and the crest of the reflection panel can affect the luminosity of the lamp illuminant structure. The height difference between the luminous body and the crest of the reflection panel may be from about 0 to about 10 millimeters. In an exemplary embodiment of the lamp illuminant structure, a height difference between the luminous body and the crest of the reflection panel is about 0 millimeters.

In one exemplary embodiment of the lamp illuminant structure as mentioned above, the chamber internal wall of the box is integrated with a slope for the arrangement of the luminous body thereon. As described below, luminosity of the lamp illuminant structure can be effected by an angle formed by the slope relative to the chamber internal wall, arranged as a perpendicular plane with the lamp box. In one embodiment, the slope forms an angle from about 30 degrees to about 60 degrees with the chamber internal wall arranged as a perpendicular plane with the lamp box.

In accordance with one exemplary embodiment of the lamp illuminant structure as mentioned above, the box is further provided with a diffusing panel corresponding to a reflection plane of the reflection panel. It will be appreciated that references herein to a diffusing panel or to an optically-transmissive plate “corresponding to a reflection plane of the reflection panel” signify embodiments wherein the diffusing panel or the optically-transmissive plate is positioned to receive a substantial portion of the light reflected by the reflection panel.

In addition, as the lamp illuminant structure of the present invention is primarily formed with simple components such as luminous bodies and reflection panel, a fine illuminating effect can thus be obtained. As is discussed more fully below, the lamp illuminant structure can be configured potentially without the use of a light guide plate to assist illumination, potentially lowering manufacturing cost, saving labor hour of assembly, and/or achieving improved productivity, and reducing the weight of the lamp illuminant structure.

In addition in accordance with one exemplary embodiment, when being assembled for use, a luminous body such as an array of light emitting diodes (LEDs) can be directly assembled on the slope to achieve the effect of more convenient assembly and enhanced productivity.

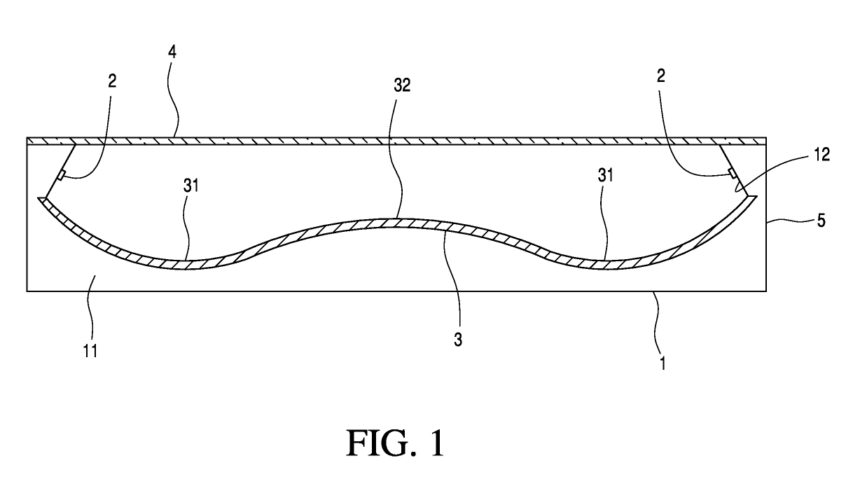

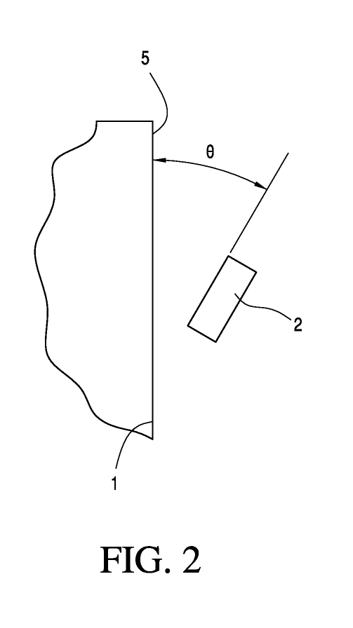

With reference now to FIGS. 1-9, exemplary embodiments of the lamp illuminant structure will be described in more detail. First, as shown in FIG. 1, the lamp illuminant structure in the present invention is provided with a box 1. A luminous body 2 can be provided on the internal wall 5 at each of two sides of the chamber 11 within lamp box 1. The luminous body 2 is a LED and forms an angle theta (θ) (as shown in FIG. 2) with the chamber internal wall 5 arranged as a perpendicular plane. In the preferred form of the lamp box 1, the perpendicular plane substantially coincides with the internal wall 5 at each of the two sides. A reflection panel 3 is provided in the chamber 11 of the box 1 and is a wavy reflection plane including two troughs 31 and one crest 32 located between two troughs 31; the crest 32 of the reflection panel 3 forms a height difference from the luminous body 2, and a diffusing panel 4 is arranged in front of the box 1 to transmit light reflected by the reflection panel 3. In accordance with one exemplary embodiment, the wavy reflection panel is comprised of two troughs 31 and one crest 32. The phrases “chamber internal wall arranged as a perpendicular plane”, and “chamber internal wall arranged as a perpendicular plane with the lamp box”, herein denote a plane at each of the sides of chamber 11 that is perpendicular to the diffusing panel 4 (or more generally, that is perpendicular to a light emission area of a lamp box or other lighting fixture).

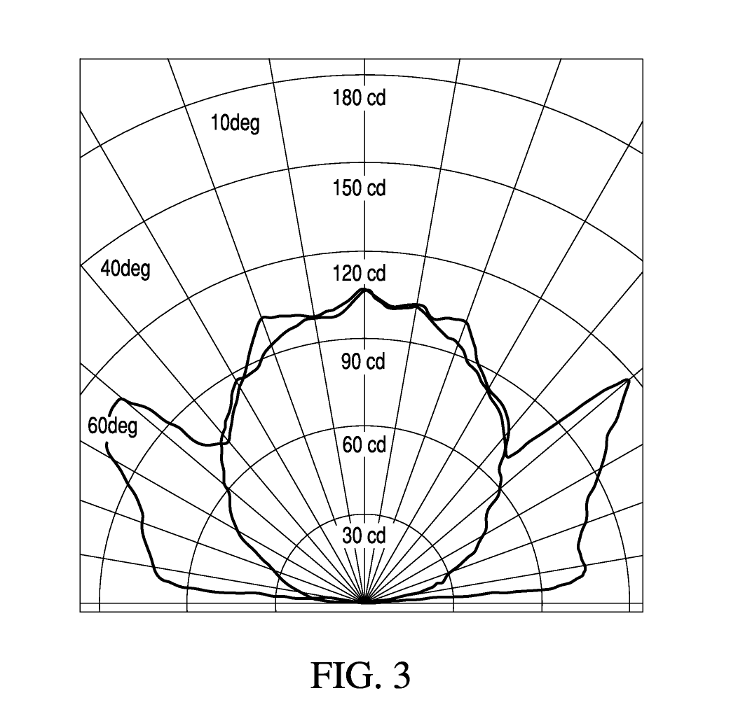

Based on the above, when in use as shown in FIG. 3, the luminous body 2 is initiated or otherwise powered to emit light. At this moment, the luminous body 2 provided on the internal wall of two sides of the chamber 11 in the box 1 conducts electricity and illuminates. Light rays emitted from the two luminous bodies 2 respectively project toward the two troughs 31 adjacent to the reflection panel 3 to form multiple reflected rays in the two troughs 31, while the reflected rays projected on two troughs 31 can become intensive and interlaced and be emitted to the front diffusing panel 4. The reflected light rays are gathered and diffused by the diffusing panel 4 to achieve the effect of providing light rays that evenly project out of the lamp illuminant structure, thus defining a light emission area.

As shown in FIGS. 3 to 9, the performance of various embodiments where the angle that the luminous body 2 projects on the trough 31 of the reflection panel 3 is adjusted, and the distance between the luminous body 2 and the crest 32 of the reflection panel 3 is adjusted too, is illustrated, showing examples of various illuminating brightness and illuminating ranges.

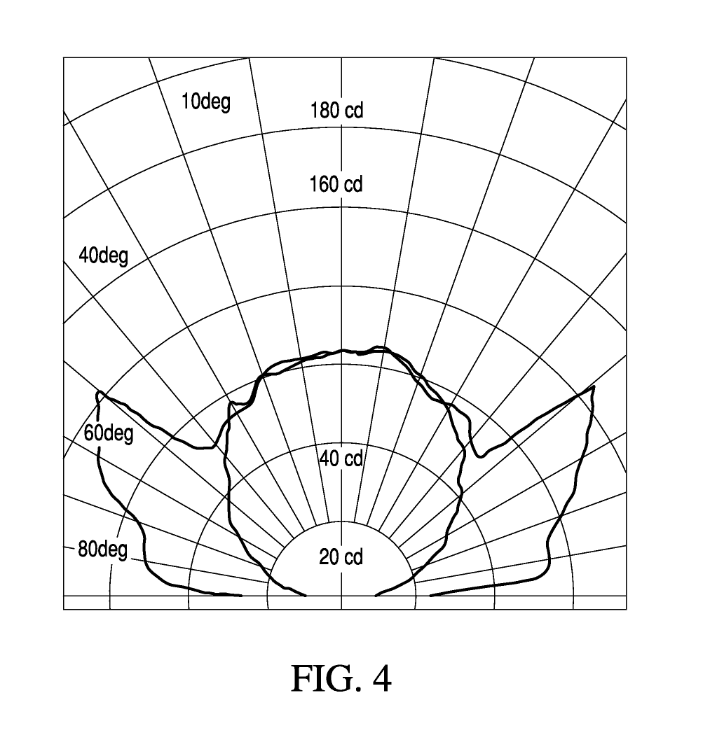

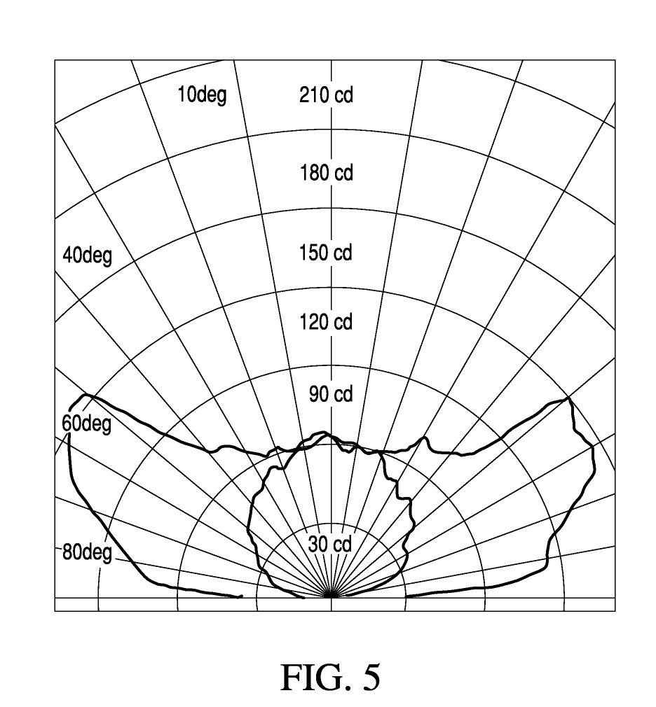

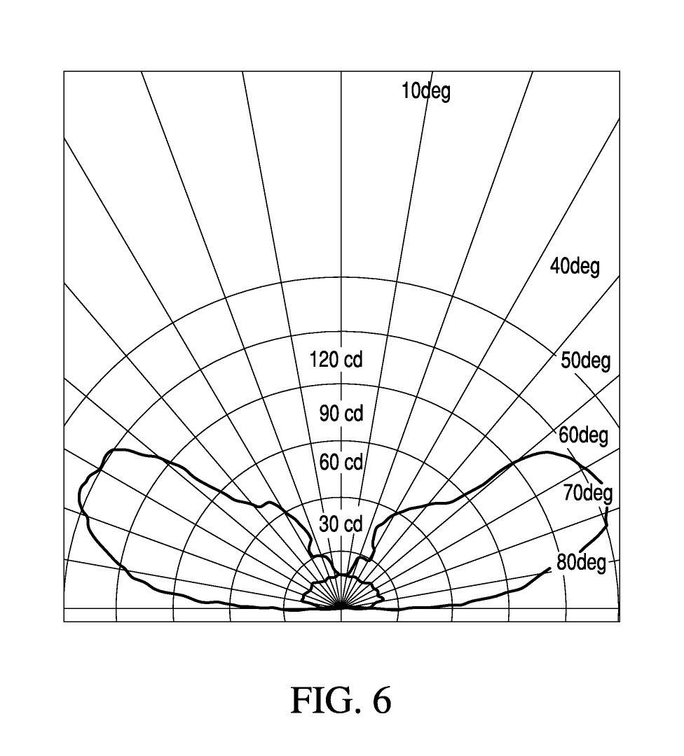

FIG. 3 is an example where the angle that the luminous body 2 projects on the trough 31 of the reflection panel 3 is about 0 degrees and the distance between the luminous body 2 and the crest 32 of the reflection panel 3 is about 0 millimeters. FIG. 4 is an example where the angle that the luminous body 2 projects on the trough 31 of the reflection panel 3 is about 0 degrees and the distance between the luminous body 2 and the crest 32 of the reflection panel 3 is about 10 millimeters. FIG. 5 is an example where the angle that the luminous body 2 projects on the trough 31 of the reflection panel 3 is about 0 degrees and the distance between the luminous body 2 and the crest 32 of the reflection panel 3 is 30 millimeters. FIG. 6 is an example where the angle that the luminous body 2 projects on the trough 31 of the reflection panel 3 is about 0 degrees and the distance between the luminous body 2 and the crest 32 of the reflection panel 3 is about 62 millimeters. From the above, it can be seen that when the angle that the luminous body 2 projects on the trough 31 of the reflection panel 3 is identical, as the distance between the luminous body 2 and the crest 32 of the reflection panel 3 is increased, the luminosity illustrated in candelas becomes weaker.

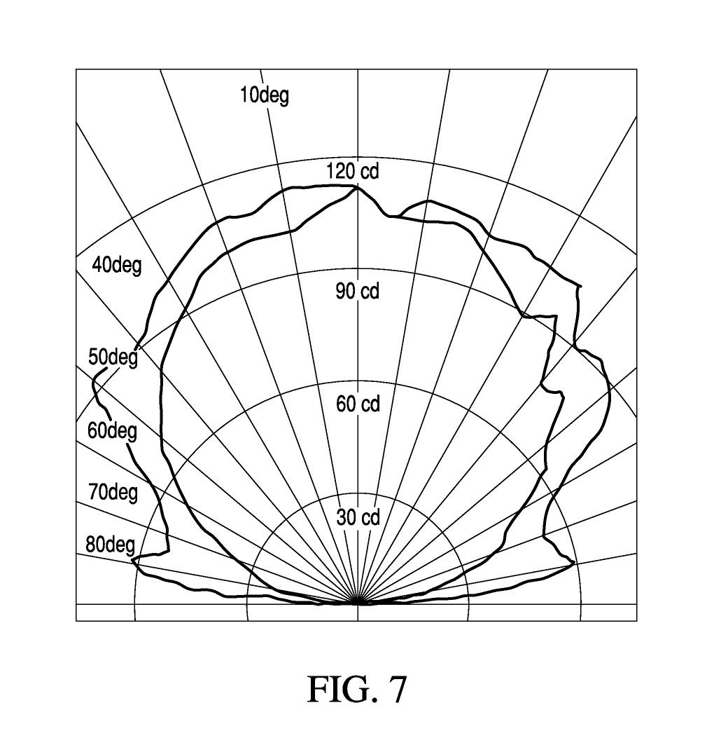

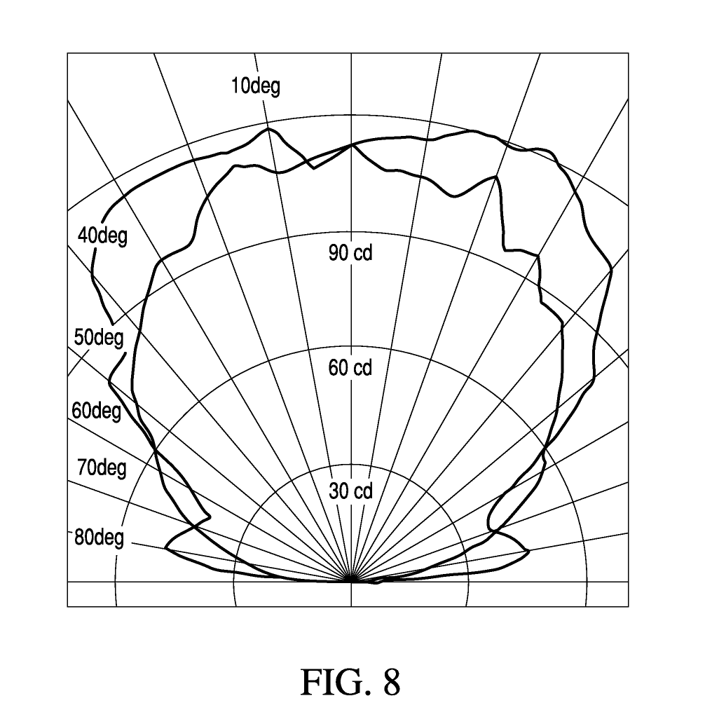

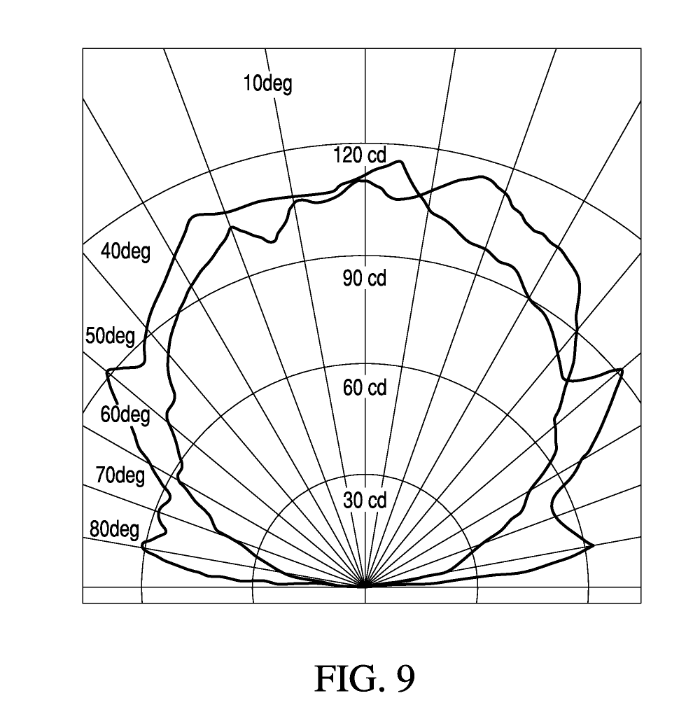

Referring again to the example of FIG. 3, where the angle that the luminous body 2 projects on the trough 31 of the reflection panel 3 is about 0 degrees and the distance between the luminous body 2 and the crest 32 of the reflection panel 3 is about 0 millimeters, FIG. 7 is an example where the angle that the luminous body 2 projects on the trough 31 of the reflection panel 3 is about 30 degrees and the distance between the luminous body 2 and the crest 32 of the reflection panel 3 is about 0 millimeters. FIG. 8 is an example where the angle that the luminous body 2 projects on the trough 31 of the reflection panel 3 is about 45 degrees and the distance between the luminous body 2 and the crest 32 of the reflection panel 3 is about 0 millimeters. FIG. 9 is an example where the angle that the luminous body 2 projects on the trough 31 of the reflection panel 3 is about 60 degrees and the distance between the luminous body 2 and the crest 32 of the reflection panel 3 is about 0 millimeters. From the above it can be seen that when the distance between the luminous body 2 and the crest 32 of the reflection panel 3 is identical, as the angle that the luminous body 2 projects on the trough 31 of the reflection panel 3 becomes larger, the illuminating range becomes larger.

Therefore, the angle that the luminous body 2 projects on the trough 31 of the reflection panel 3 adopted in the lamp illuminant of the invention is from about 30 degrees to about 60 degrees in one preferred embodiment, and the distance between the luminous body 2 and the crest 32 of the reflection panel 3 is from about 0 millimeters to about 10 millimeters. In accordance with one exemplary embodiment, where a height difference between the crest 32 of the reflection panel 3 and the luminous body 2 is about 0 millimeters, increased illuminating brightness and illuminating range is provided.

It will be appreciated that in accordance with one exemplary embodiment, the lamp illuminant structure can be manufactured as a simple structural lamp having a fine illumination effect, through using a box 1, a luminous body 2, a reflection panel 3 and a diffusing panel 4. In accordance with one embodiment, there is no need to employ an expensive light guide plate, and hence the manufacturing cost of the lamp box, and the weight of the lamp box, can be reduced. Since the structure is simple, labor hour of assembly is relatively lowered and productivity can be improved.

Referring to FIG. 1 again, in the illustrated lamp illuminant structure, the internal wall of two sides of the chamber 11 in the box 1 can be integrated with a slope 12 for the arrangement of the luminous body 2 thereon, where the slope forms an angle from about 30 degrees to about 60 degrees with the chamber 11 internal wall arranged as a perpendicular plane with the lamp box. In such a way, when being assembled for use, the luminous body 2 can be directly assembled on the slope 12 of the box 1 to achieve the effect of more convenient assembling, and to enhance productivity of the lamp illuminant structure.

It will be appreciated that the above examples and Figures do not limit the structural pattern or dimension of the invention. Any appropriate change or modification from that known to one skilled in the art having common knowledge in the relevant field can all be regarded as within the scope of the disclosed technology.

The above-described lamp illuminant structure may include one or more of the following advantages.

The lamp illuminant structure can be mainly comprised of a luminous body and a reflection panel, in which the respective projection of two luminous bodies on two troughs of the reflection panel can generate intensive interlaced bright light rays to project so as to achieve a fine illuminating effect.

The lamp illuminant structure can be mainly comprised of a luminous body and a reflection panel, and using the design with a wavy reflection panel can generate bright light rays to project. No expensive light guide plate is needed to assist illumination, and therefore the manufacturing cost and weight may be reduced.

The lamp illuminant structure can be mainly comprised of simple structures such as a luminous body and a reflection panel; this simple structure can achieve benefits such as lowering manufacturing cost and saving labor-hour of assembly as well as improving productivity.

In the lamp illuminant structure described above, the chamber internal wall of the box on which the luminous body is arranged, directly forms a slope that forms an angle from about 30 degrees to about 60 degrees with the perpendicular plane. Thus when being assembled for use, the luminous body can be directly assembled on the slope to achieve the effect of more conveniently assembling and enhancing productivity. In a preferred embodiment, the luminous body comprises an array of light emitting diodes (LEDs).

With reference now to FIGS. 10-20, embodiments of a light emitting diode (LED) light fixture are provided, including the lamp illuminant structure of the invention.

FIGS. 10-14 show exemplary embodiments of a light fixture 110 including a lamp illuminant structure in combination with luminous bodies in the form of light emitting diode (LED) arrays. As shown in the various figures, the light fixture 110 includes a frame 114 containing at its front face an optically-transmissive plate 112. In accordance with one embodiment, the optically-transmissive plate 112 is a flat, thin transparent or translucent sheeting or film that passes light from other elements of a lamp illuminant structure of light fixture 110. The frame 114 provides structural support, and contains components of the light fixture such as the reflection panel; arrays, strips, or bars of LEDs; and power circuitry (also referred to as driving circuitry, and as LED power circuitry or LED driving circuitry). Furthermore, frame 114 provides heat dissipation. As is described more fully below, the frame can be configured to house or otherwise support LED power circuitry as well as associated wiring and electrical connections between the power circuitry and the LED arrays.

It will be appreciated that references to an “optically-transmissive plate” or to an “optically-transmissive panel” are meant to include sheeting or film that receives light reflected by the reflection panel and transmits light from the light emission area (e.g. front surface) of the lamp illuminant structure or light fixture. The optically-transmissive plate can be rigid or flexible, and may include a single layer or multiple layers of translucent material. The optically-transmissive panel can be configured to modify or otherwise direct the distribution of light received from the reflection panel in a variety of ways. For example, the optically-transmissive panel can include a diffusing panel, which scatters the light received from the reflection panel; and may also include a collimating panel, which concentrates or shapes the light received from the reflection panel.

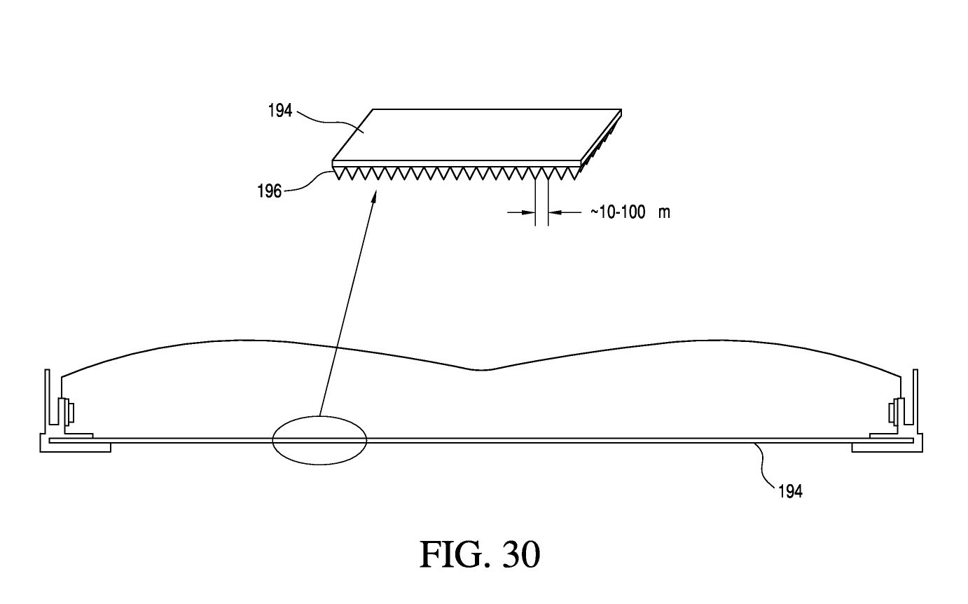

One type of optically-transmissive panel that offers various advantages in the present invention is a micro-lens diffuser plate. Micro-lens diffusers utilize light-refraction physics governing light rays traveling through and exiting an optical plate or film. In an optical plate or film with surface elements, the slope of the surface elements dictates the exit direction of a light ray. In a micro-lens diffuser plate or film, light-steering elements called micro-lenses typically cover the entire exit side. Micro-lens arrays used as diffusers are known to produce uniform scatter patterns with high efficiency. Two key factors affecting luminance of light exiting the micro-lenses is the contour of the micro-lenses, and the pitch between micro-lenses. For example as shown in FIG. 30, the micro-lens diffuser plate may a plurality of micro-lenses having a pitch from about 10 microns to about 100 microns.

Depending on the particular application the light diffuser or other optically-transmissive plate or panel can be made of any suitable material, such as a soft film, hard, abrasion-resistant sheeting or film, or a weatherable sheeting or film for outdoors applications. It will be further appreciated that the optically-transmissive plate or panel may include multiple films or sheeting employed as part of a stack.

The light fixture can be designed to provide uniform lighting; alternatively if the goal is high uniformity over a target angular illumination range, most of the light from the light fixture can be directed towards that illumination range. For example, in the light fixture 110 of FIGS. 10-14, using a diffusing panel (which scatters light passing through the panel) as the optically-transmissive panel 112 may output light over a relatively broad angular field of view. Alternatively, using a micro-lens diffuser plate the light fixture may output light over a relatively narrow angular field of view, while providing increased luminous intensity at the central region of the angular field of view.

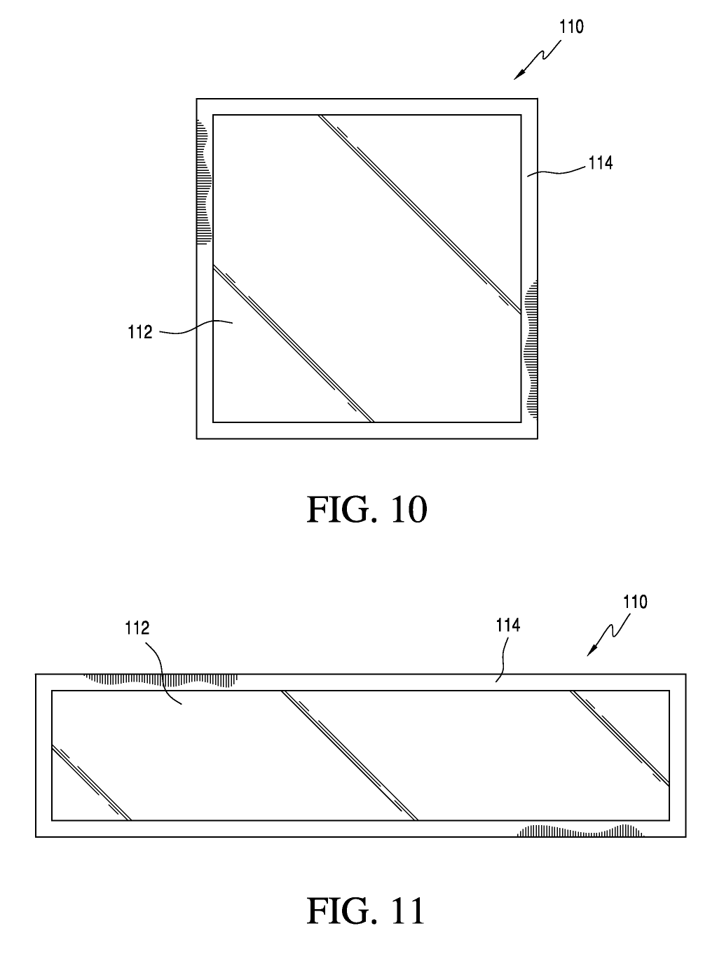

The light fixture 110, including the frame 114, optically-transmissive plate 112, and lamp illuminant assembly structures, may take on a variety of dimensions and form factors, including, but not limited to, rectangular and other polygonal forms. For example, the light fixture can be square (see FIG. 10) with a size of approximately twenty-four inches by twenty-four inches, approximately nine inches by nine inches, or approximately twelve inches by twelve inches. By way of example, the light fixture 110 also can be rectangular with a size of approximately one foot by four feet (1 foot×4 feet) (see FIG. 11) or a size of approximately two feet by four feet (2 feet×4 feet) (see FIG. 12).

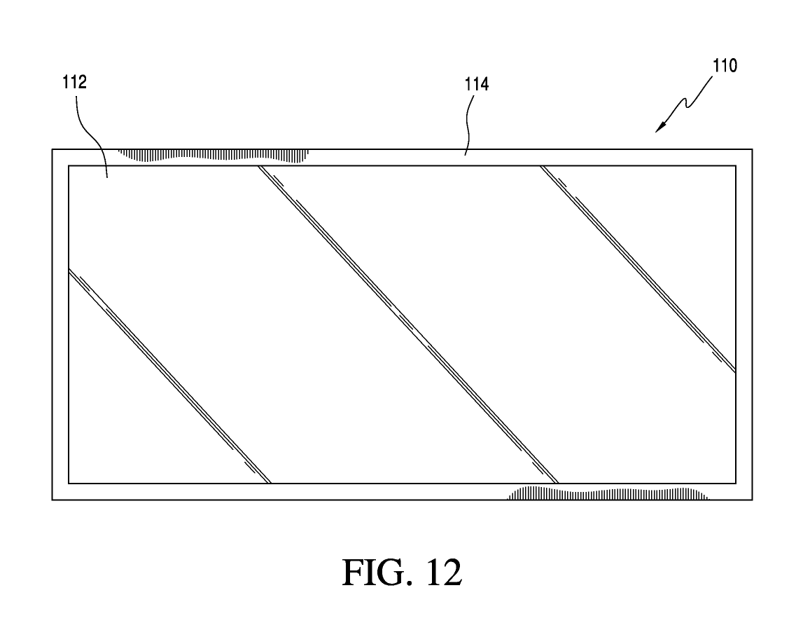

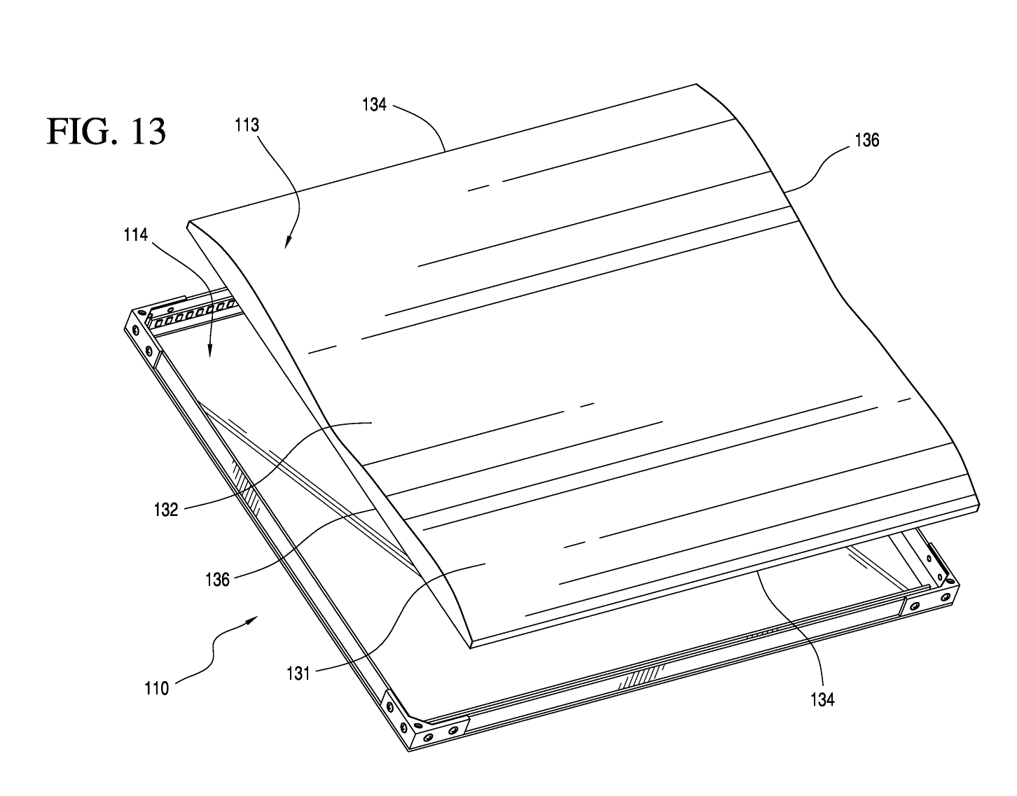

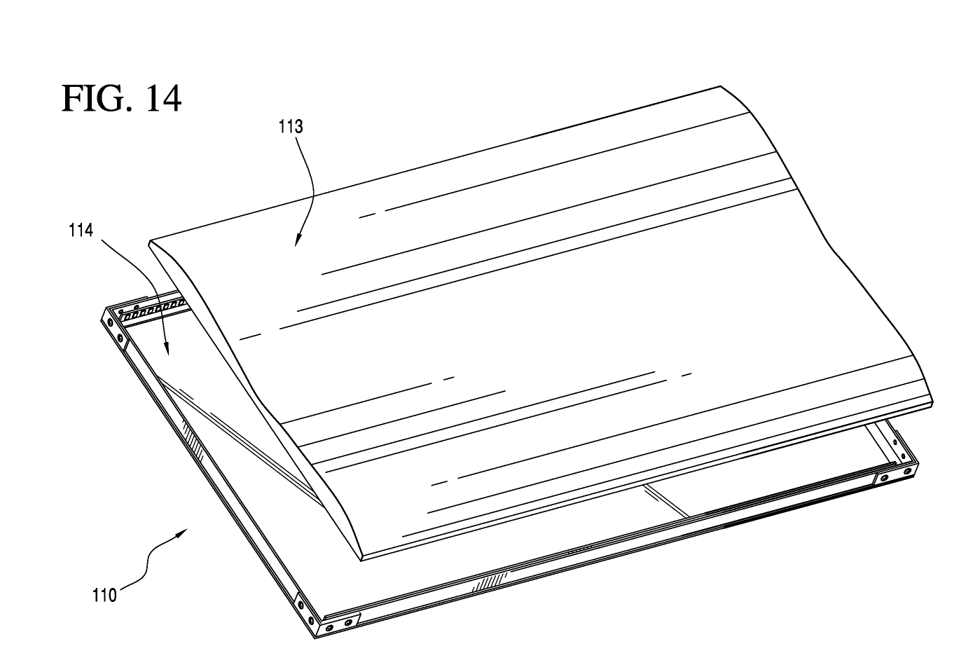

FIGS. 13 and 14 illustrate preferred configurations of reflector panel 113 for use with a square light fixture (FIG. 13) and a rectangular light fixture (FIG. 14). It will be seen in FIG. 14 that the reflection panel 113 is oriented so that that crest 132 and outer edges of the troughs 131 extend along the long axis of the light fixture 110. The reflector panel 113 may have a substantially cylindrical form, in which a cross section of the reflection panel (such as the crest and troughs configuration shown in FIG. 1) remains constant along a family of parallel generating lines that are perpendicular to the cross section. Reflection panel 113 has edges 134 defining the outer limits of the troughs 131(herein sometimes called the “parallel edges” i.e. edges parallel to the generating lines or “parallel axis” of the reflector panel 113); and edges 136 at the ends of troughs 131 and crest 132 (herein sometimes called “cross-sectional edges”, i.e. edges corresponding to the wavy cross section or “cross sectional axis” of reflector panel 113).

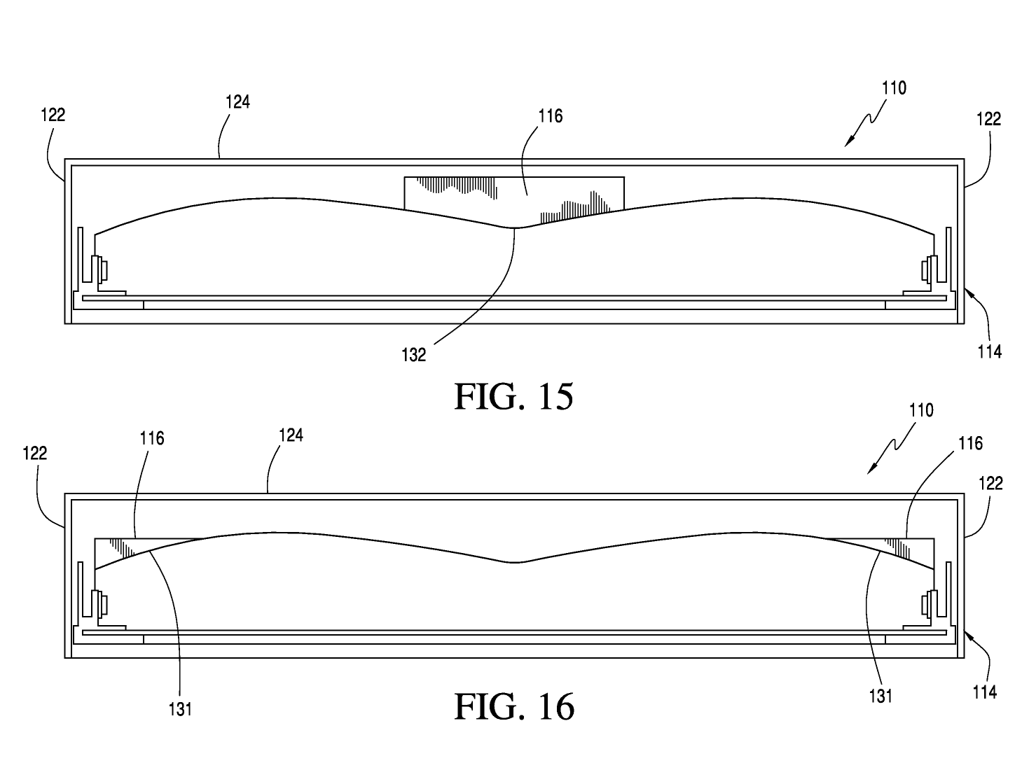

The frame 114 can be configured to define or otherwise provide one or more channels to support power circuitry, associated wiring or other electrical connectors, as well as LED arrays or bars. By housing the power circuitry within the frame 114 of the light fixture 110, this configuration provides for a self-contained and relatively compact light fixture that lends itself to surface mounting applications. In one embodiment, the frame 114 includes side walls 122 and a rear cover 124, and the power circuitry 116 is disposed or otherwise housed within the light fixture behind the waveform reflector panel. In the embodiment shown in FIG. 15, power circuitry 116, including power supply modules and other associated driving circuitry, is disposed behind the crest 132 of the waveform reflector panel between the adjacent troughs of the reflector panel. Alternatively as shown in FIG. 16, power circuitry 116 can be disposed in recesses behind the outer portions of troughs 131.

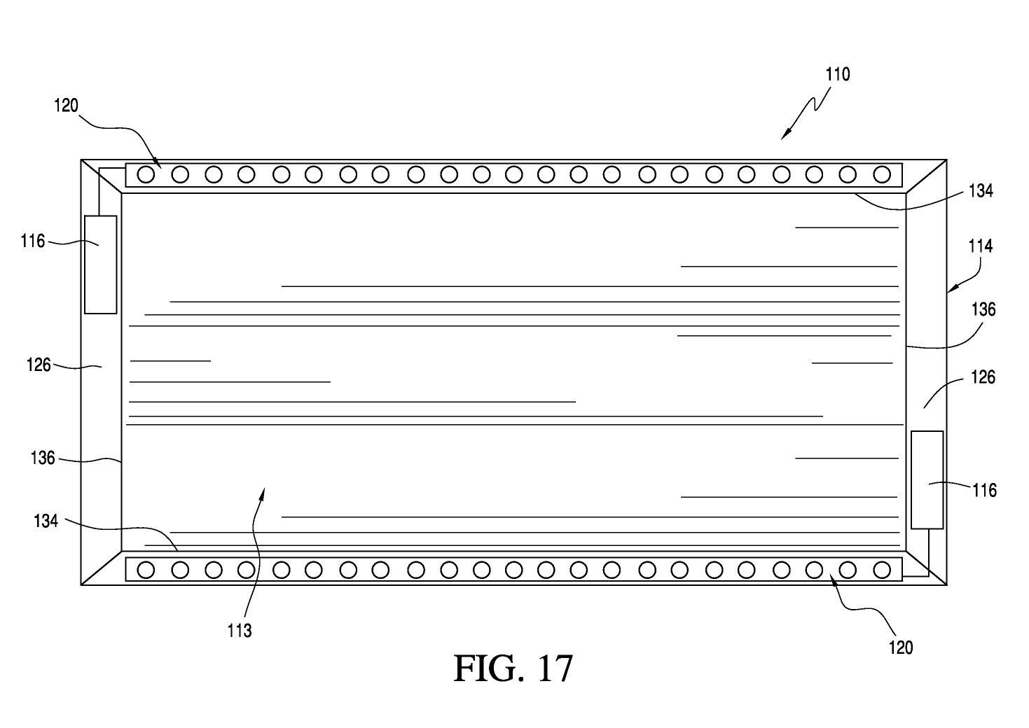

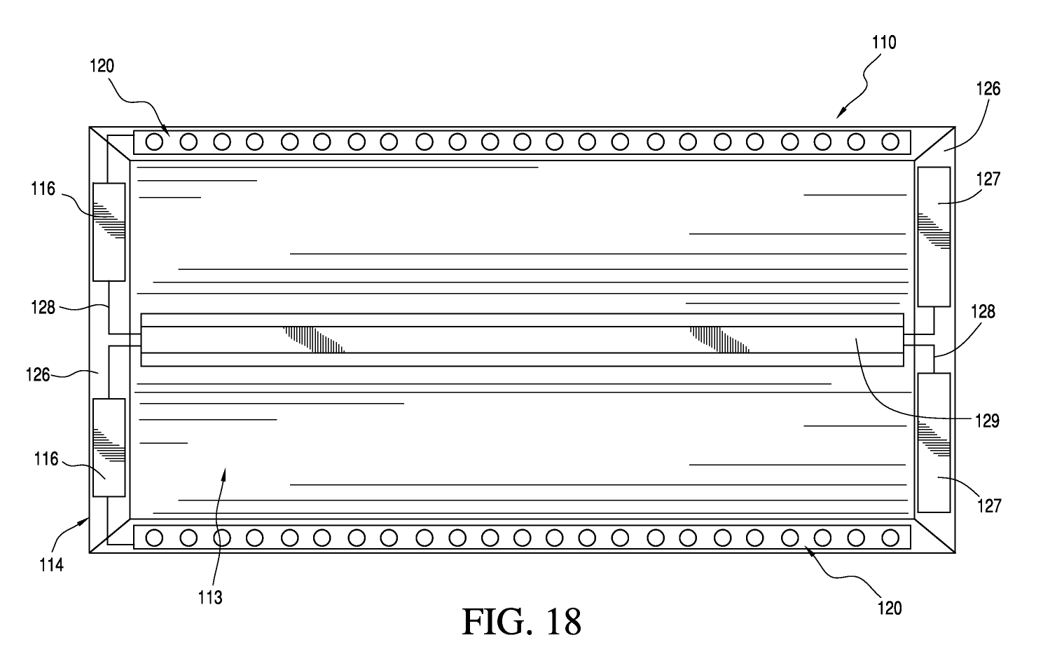

In another configuration shown in FIGS. 17 and 18, the frame 114 includes channels 126 between the cross-sectional edges 136 of reflector panel 113 and corresponding edges of frame 114. FIG. 17 shows an embodiment with a first LED driver 116 positioned in one of the channels 126 and electrically coupled to and configured to control a first LED array (e.g., an LED strip 120). A second LED driver 116 is positioned in the opposite channel 126 and is coupled to and configured to control the second LED array 120. The first and second LED arrays 120 are located adjacent the opposite parallel edges 134 of reflector panel 113.

FIG. 18 shows an arrangement that houses or disposes various components in channels 126 as well as behind the reflector panel 113. One of the channels 126 contains wiring compartments 127 that house wiring or other electrical connectors 128. Electrical connectors 128 conduct AC power from an external power source, and are routed across the reflector panel assembly 113 to connect to LED drivers 116 at the opposite channel 126. The light fixture 110 may include a wire way 129 to cover the electrical connectors 128 routed behind the reflector panel assembly. In the embodiment of FIG. 18, the reflector panel assembly 113 together with wire way 129 can serve as a rear surface of the light fixture 110, whereas the configuration of FIGS. 15 and 16 includes a separate rear cover 124 over the reflector panel 113.

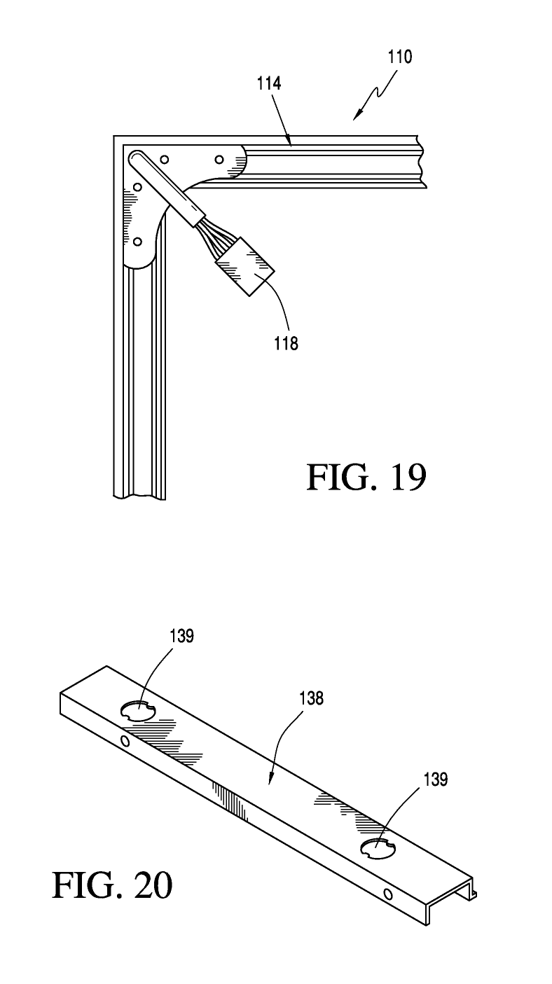

Light fixture 110 may include one or more wiring entry, such as a conduit or aperture formed in frame 114, to receive wiring or other electrical connectors 128 electrically coupled to the external AC power supply. The wiring entry may be located at a corner or edge of frame 114, or may be behind the reflector panel 113 e.g. as a feature of rear cover 124 or wire way 129. FIG. 19 shows a wiring conduit 137 at the corner of frame 114. FIG. 20 shows a cover 138 for the channel 126 containing wire compartments 127 (FIG. 18); cover 138 has knockout apertures 139 or other apertures for routing electrical connectors carrying AC power from an external source.

Desirably, the power control circuitry 116 has a compact design in order to reduce the profile of light fixture 110. Such compact power and control circuitry can be obtained by employing miniaturized power and/or control boards. For example, a programmable logic controller (PLC) motherboard can serve as a real-time clock with timing control logic to regulate operation of the LED arrays 120. As is discussed more fully below, multiple arrays, sets or configurations of LEDs can be operated in an alternating manner according to a predetermined timing sequence.

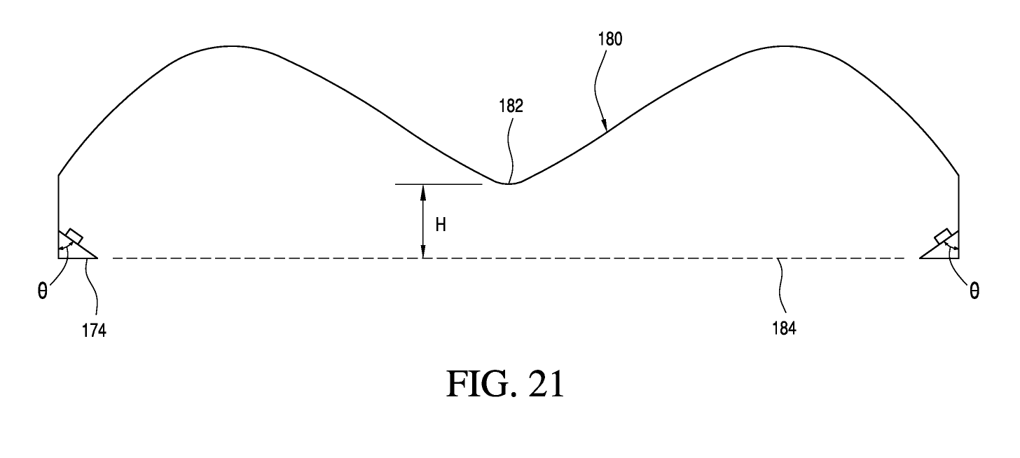

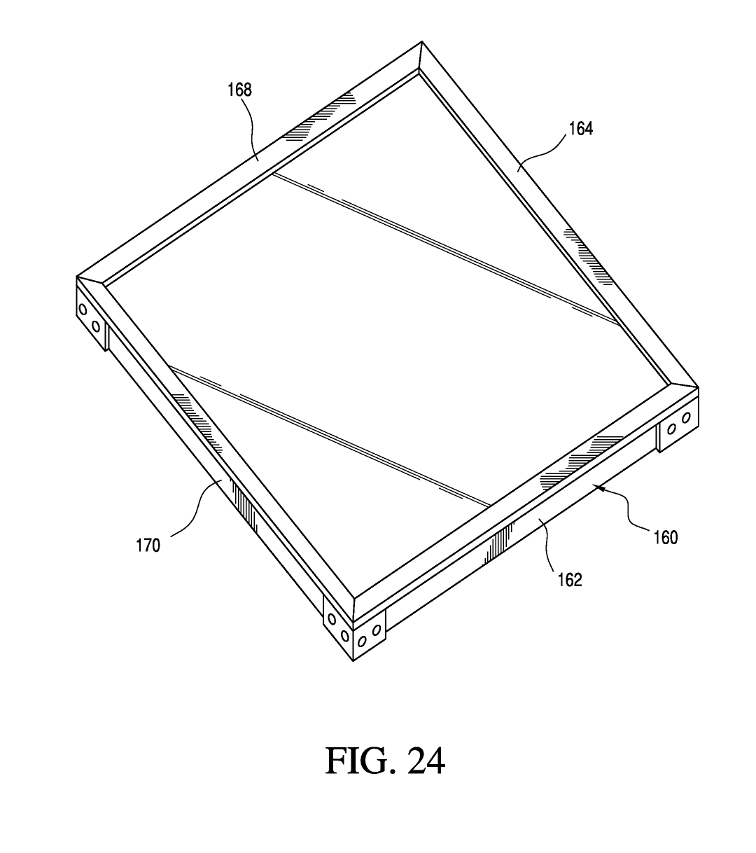

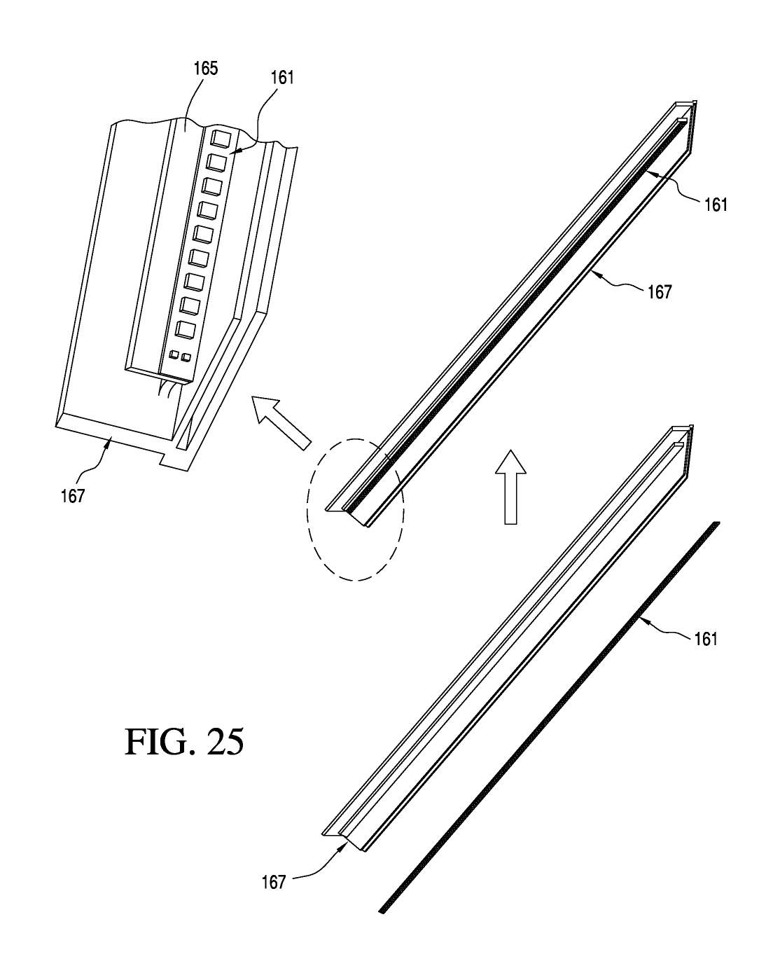

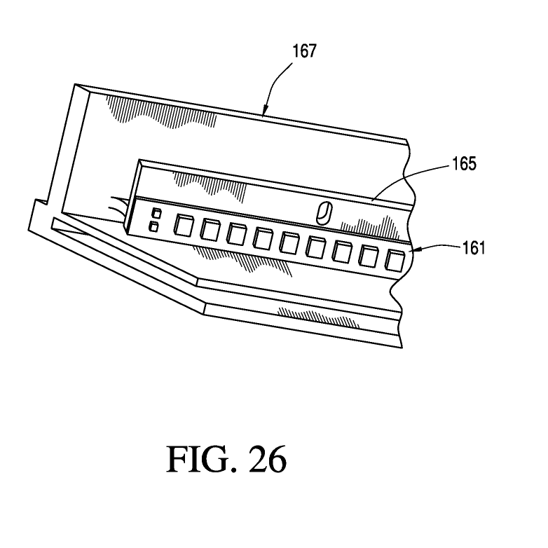

Turning now to FIGS. 21-32, other exemplary embodiments of the LED light fixture will be discussed. In accordance with one embodiment, the light fixture includes a frame. As shown in FIG. 24, for example, the frame, designated generally as 160, can be made up of four segments 162, 164, 166, 168 of extruded aluminum, where sections of the frame include an outer side wall (also referred to simply as a side wall) and an inner support wall configured to support one or more arrays of LEDs. The segments 162, 164, 166, 168 of the frame can be coupled using any suitable coupling mechanism, such as metal corner assemblies or brackets (see FIGS. 24, 27 and 28).

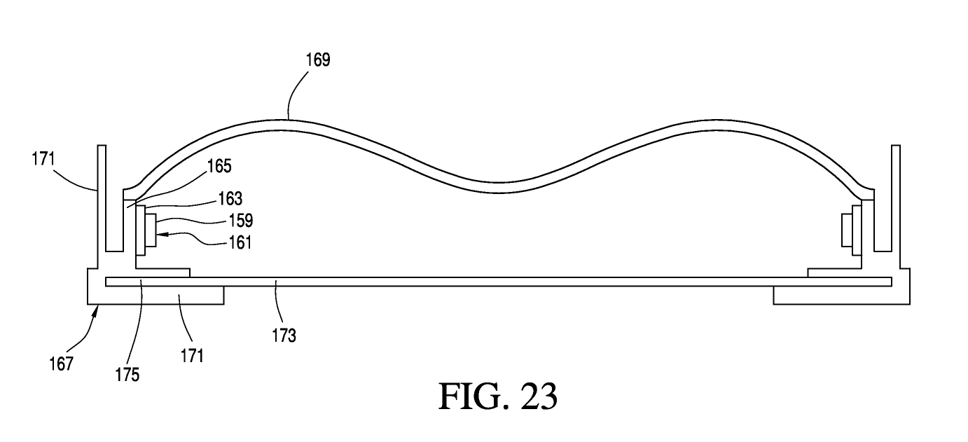

It will be appreciated that the frame can take on numerous configurations without departing from the scope of the present invention. For example, as shown in FIGS. 23, 25-26, and 31-32, the frame can include an outer side wall and an inner support wall. The outer side wall can be configured to include a recess suitable for accommodating corner brackets for assembly of the frame (see, for example, FIGS. 24-28). The inner support wall can be configured to support one or more LED arrays in a predetermined position. The frame can further include or otherwise define a recess suitable for engaging a diffusing panel or other optically-transmissive panel through which light is emitted (discussed more fully below).

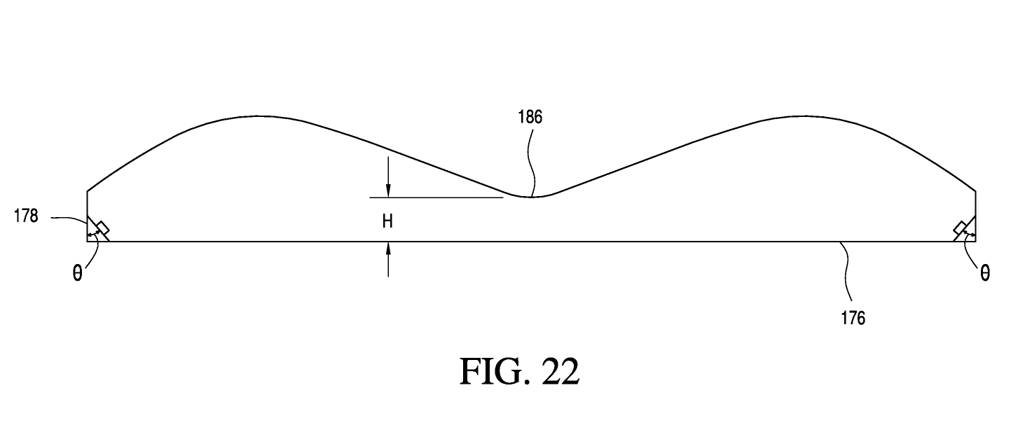

In accordance with one embodiment, the light fixture can include a diffusing panel coupled to the frame (for example, configured to be secured within a channel defined by the segments of the frame) and disposed in a plane perpendicular to the side walls of the frame. For example, the light fixture can include a conventional (light-scattering) diffuser plate, or can include a micro-lens diffuser plate (see, for example, FIG. 22 and FIG. 30).

Referring to FIG. 23, an embodiment of the light fixture is illustrated in which an LED strip 161 includes an array of LEDs 159 mounted on a bar or other packaging 163. The LED strip is mounted on an inner support wall 165 of a frame, the frame being designated generally as 167. The inner support wall may support reflector plate 169. An outer side wall 171 is integrally formed with the inner support wall 165. An optically transmissive panel (e.g. diffusing panel, diffusor panel, or light diffuser) 173 may be accommodated within a recess 175 formed within a portion of the frame 167 defining an outer side wall. In FIGS. 23, 25 and 26 the inner support wall 165 functions directly as a heat sink without the need for an additional component.

Various forms of LEDs packaging may be employed, including for example surface mounted packages that mount LEDs to a printed circuit board. Surface mounting of LEDs typically dissipates heat efficiently. However, it is understood that other LEDs packaging such as pin mounted LEDs may be utilized. LEDs packaging can increase or decrease beam angle of LEDs illumination, which in turn can affect the pattern of illumination projected by the reflection panel.

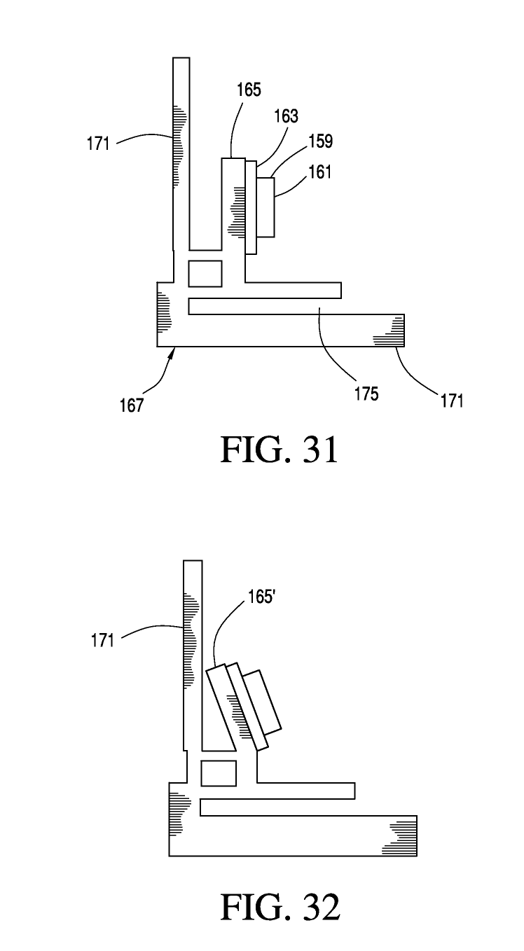

As noted above, the inner support wall and the array of LED's mounted on the inner support wall (also called slope) can be disposed at an angle relative to the side walls and the light diffuser, depending on the desired orientation of the LED array being supported by the inner support wall. For example, FIG. 31 shows an orientation in which the inner support wall 165 is oriented parallel to a side wall 171. FIG. 32 shows an embodiment having an orientation in which the inner support wall 165′ is oriented at an angle (e.g., an angle of about 30 degrees to about 60 degrees relative to the outer side wall 171).

The schematic diagrams of FIG. 21 and FIG. 22 illustrate orientation of the LED arrays at various angles theta (Θ), relative to a side wall and/or to a plane perpendicular to a light emission area of the lamp illuminant structure (or light fixture). Whether the lamp illuminant structure (or light fixture) does, or does not, include an optically-transmissive panel that is capable of collimating or patterning transmitted light can significantly affect angles theta (Θ) at which the LED arrays operate with greatest efficiency. The embodiment of FIG. 21 corresponds to a lamp illuminant structure with no optically transmissive panel at the light emission area. In this embodiment, the LED arrays are preferably oriented at an angle theta (Θ) from about 30 degrees to about 60 degrees relative to a plane perpendicular to a side wall 174. The embodiment of FIG. 22 illustrates an embodiment including a micro-lens diffuser plate 176 perpendicular to a side wall 178 of the light fixture. In this embodiment the LED arrays may operate efficiently at a greater range of orientations, i.e. may be oriented at an angle theta (Θ) from about 0 degrees to about 90 degrees relative to a plane perpendicular to the side wall.

The schematic diagrams FIGS. 21-22 also illustrate the effect of an optically-transmissive panel on the height or thickness of the light fixture. The overall height of the light fixture includes the crest-to-trough height of the waveform reflector panel; the height or separation H between the waveform reflector panel and the light emission area of the lighting fixture (e.g. diffusing panel); and any additional height due to mechanical requirements such as space for power circuitry. Generally the lighting device embodiment of FIG. 21 has a greater overall height than the embodiment of FIG. 22.

It will be appreciated that the waveform reflector plate can be configured in a number of ways without departing from the scope of the disclosed technology. For example, as shown in FIGS. 21 and 22, the crest 182 of the waveform reflector plate can be positioned or otherwise spaced at a distance H from the light emission area of the light fixture (e.g., from a diffusing panel or other type of light diffuser assembly or optically-transmissive plate). In accordance with one exemplary embodiment (e.g., FIG. 21), the crest 182 is positioned at a distance of about 0 centimeters to about 5 centimeters from a light emission area 184 at the front of the light fixture. In accordance with another exemplary embodiment (FIG. 22), the crest 186 is positioned at a distance of about 3 centimeters to about 10 centimeters from an optically-transmissive panel 176 at the front surface of the light fixture.

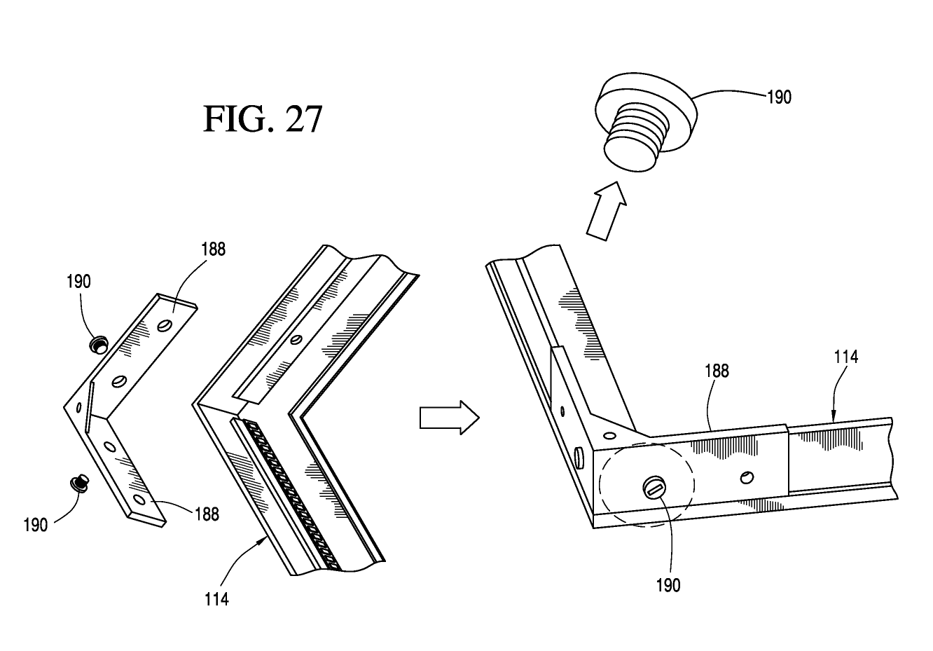

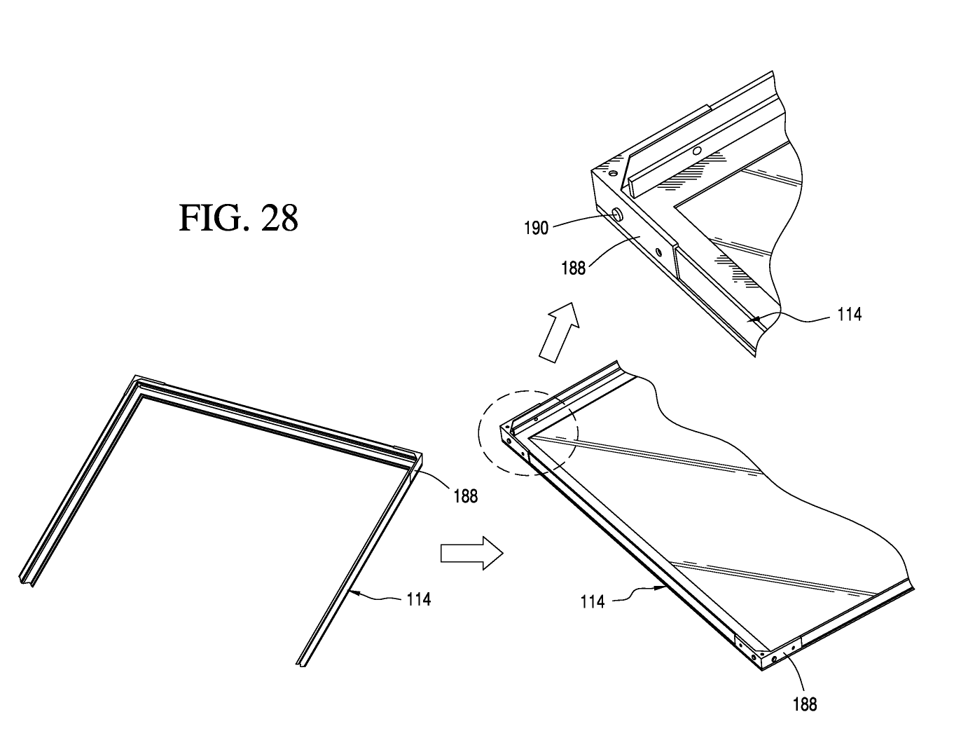

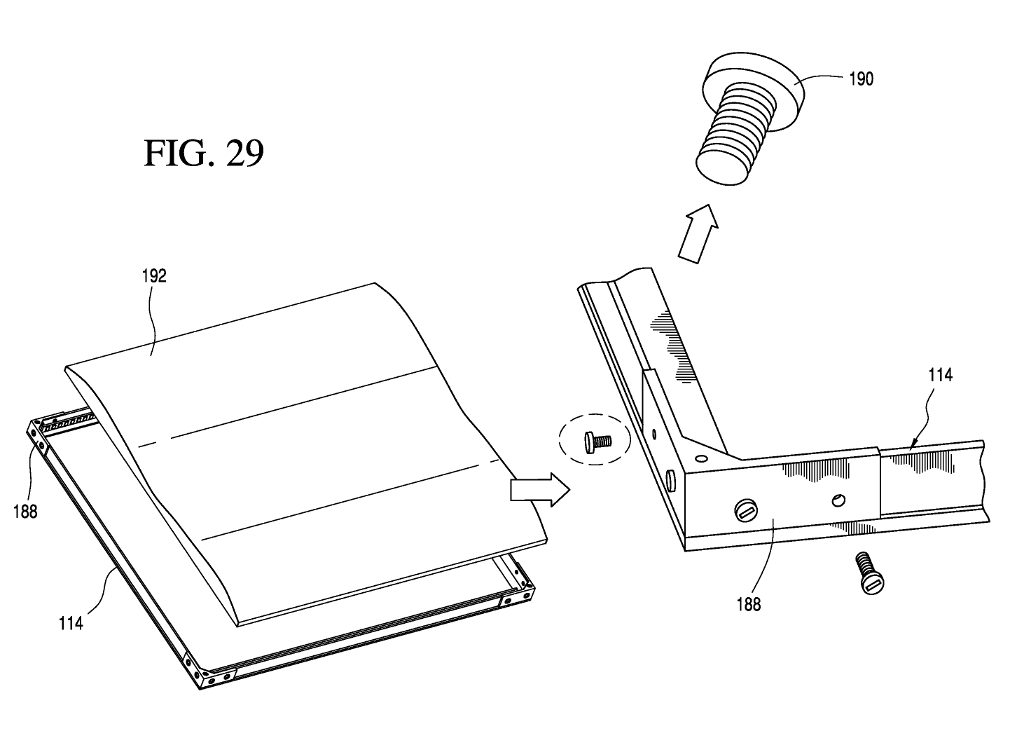

The waveform reflector plate can be coupled to the frame in a number of different ways without departing from the scope of the disclosed technology. For example, FIGS. 27-29 illustrate how the various pieces of the frame 114 can be joined using corner brackets 188 and fasteners 190. Referring to FIG. 29, the waveform reflector panel 192 can, in turn, be coupled to the frame 114 by way of the corner brackets 188 with suitable fasteners 190.

As is discussed above, the frame can take on a number of sizes and/or dimensions. For example, in accordance with one embodiment, the frame can be square with dimensions of about 2 feet by about 2 feet (e.g., about 600 millimeters by about 600 millimeters). In this exemplary embodiment, the frame is thin enough such that the frame and the diffuser plate cooperate to define a light emission area of about 545 millimeters by about 545 millimeters (see, e.g., FIG. 24).

Stated differently, in one exemplary embodiment, where the frame has a given length and a given width, the frame and the diffuser plate can cooperate to define a light emission area of about 90% the length by about 90% of the width. This ratio of light emission area to overall lateral area is believed to show an improvement over conventional designs.

In accordance with one exemplary embodiment, the frame includes a back cover coupled to the plurality of side walls. In accordance with another exemplary embodiment, the plurality of side walls is integrally formed with the back cover.

As discussed above, the waveform reflector plate can take on a number of configurations and dimensions without departing from the scope of the disclosed technology. For example, the waveform reflector plate can be configured such that the crest is positioned at a height of about 1 centimeter to about 10 centimeters relative to the troughs. In another exemplary embodiment (where the frame has a length and width of approximately 600 millimeters), the waveform reflector plate can be configured such that the crest is spaced about 120 millimeters to about 160 millimeters from the adjacent troughs.

The waveform reflector panel can include a variety of constructions and surface characteristics without departing from the scope of the disclosed technology. For example, the waveform reflector plate can be formed with or otherwise coated with a specular or non-specular reflection surface to aid in reflection and distribution of the light from the LED arrays. In one embodiment, the waveform reflector panel includes a non-specular reflection surface, such as a matte white film or sheeting as well known in the art. Edge portions of the reflector panel adjacent the LED arrays each have a specular reflection surface.

The waveform reflector plate can be formed of a thin reflective surface sheeting or film, and a rigid supporting structure (also referred to herein as a waveform cover) of any suitable material, such as aluminum, molded plastic, or composite materials.

Referring now to FIG. 30, a light fixture in accordance with the principles of the present invention is illustrated with micro-lens diffuser plate 194 with micro-lenses 196. The micro-lenses 196 preferably have a pitch of about 10 microns to about 100 microns.

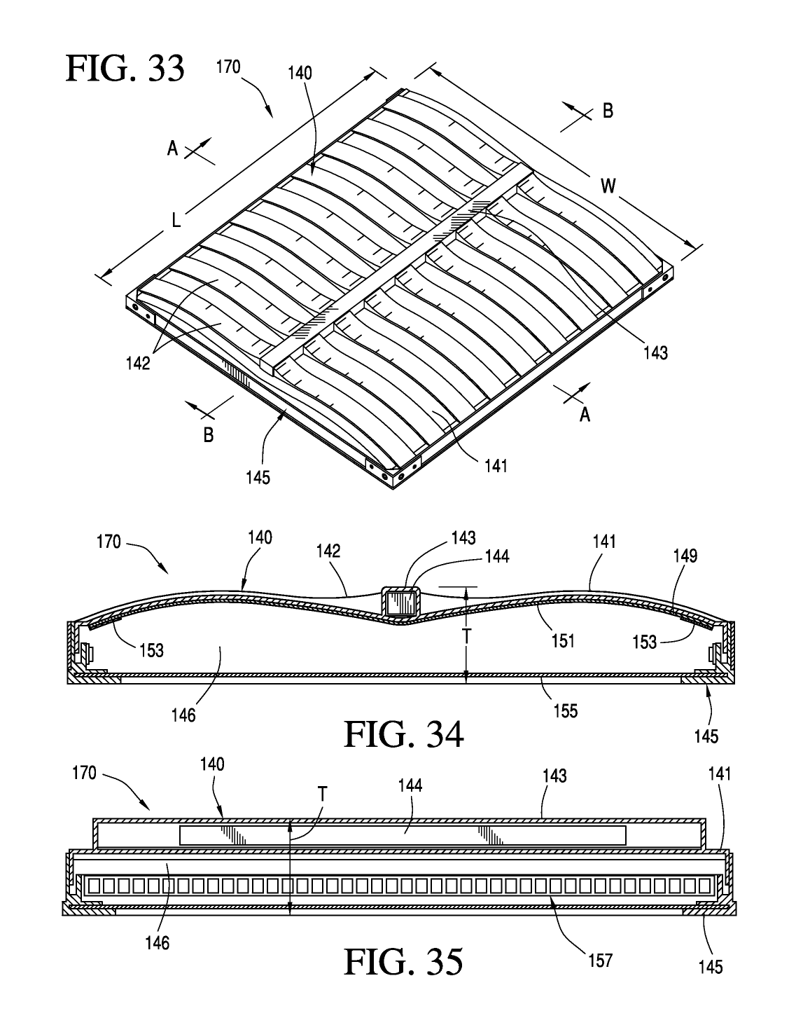

FIGS. 33-35 show an embodiment of the light fixture, designated generally as 170, with a waveform cover 140 that is relatively lightweight, yet sturdy. Waveform cover 140 includes a cover body 141 comprised of a light molded plastic such as polyethylene terephthalate (PET), formed in a troughs-and-crest configuration generally corresponding to that of the waveform reflector plate that is supported by the cover body 141. Waveform cover 140 includes reinforcing ribs 142 extending along the cross-sectional axis B-B of the waveform configuration, and a reinforcing rib 143 extending along the parallel (A-A) axis at the crest of the waveform configuration. Cross-sectional configurations of waveform cover 140 are shown in FIG. 34, a section taken at A-A; and FIG. 35, a section taken at B-B. Cover body 141 is further reinforced by frame 145, which may serve as the primary supporting structure for the remaining components of the light fixture. In exemplary dimensions of waveform cover 140, the cover frame 145 has a length, L, of about 600 millimeters; and, a width, W, of about 600 millimeters (FIG. 33), and the waveform cover 140 has a thickness, T, of about 55 millimeters (FIGS. 34, 35).

As can be seen most clearly in FIG. 34, in one preferred embodiment the configuration of reinforcing ribs, including central rib 143, can provide a secure environment for enclosing power circuitry 144. The power circuitry 144 is shown disposed behind a crest of a waveform reflector plate 149, the power circuitry being configured to electrically couple the light emitting diode (LED) array to an external power supply. The waveform reflector plate 149 preferably includes a non-specular reflection surface 151. The edges of the reflector plate 149 may have a specular reflection surface 153. In one preferred embodiment, as shown in FIG. 34, the specular reflection surface 153 is formed over the non-specular reflection surface 151. An optically-transmissive panel 155 is preferably utilized, as discussed above.

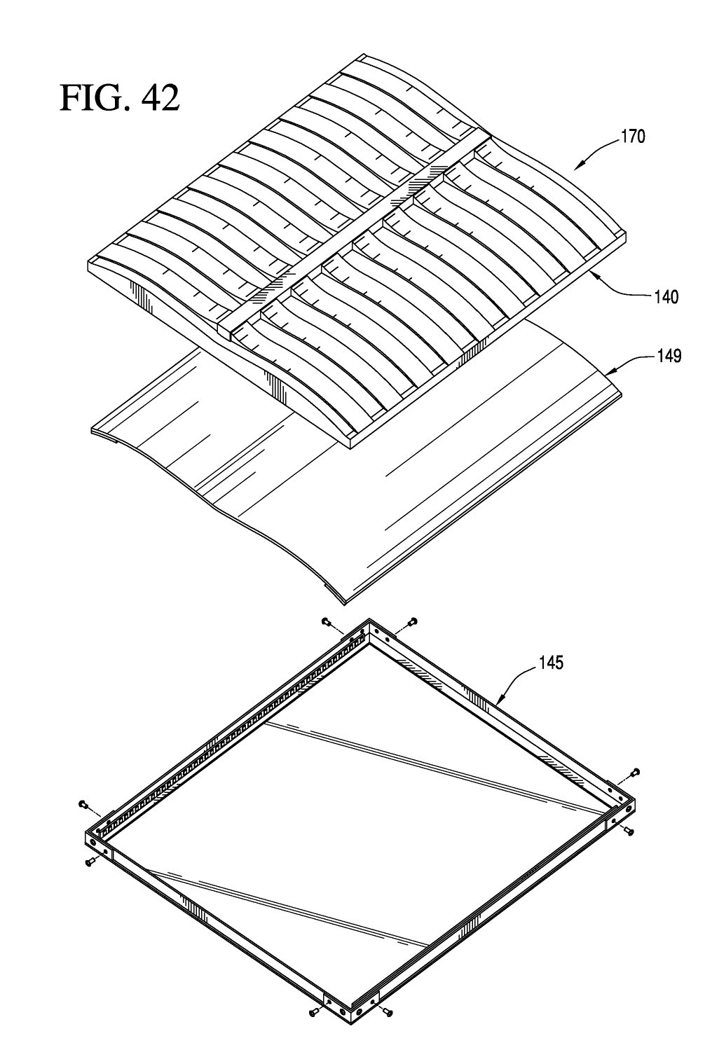

FIGS. 41-42 are additional views of a light fixture 170 with waveform cover, as shown in FIGS. 33-35. FIG. 41 is a perspective view of the light fixture 170 from the front (light emission area) surface. FIG. 42 is an exploded view showing the waveform cover 140, reflective plate 149, and frame 145 with diffuser panel.

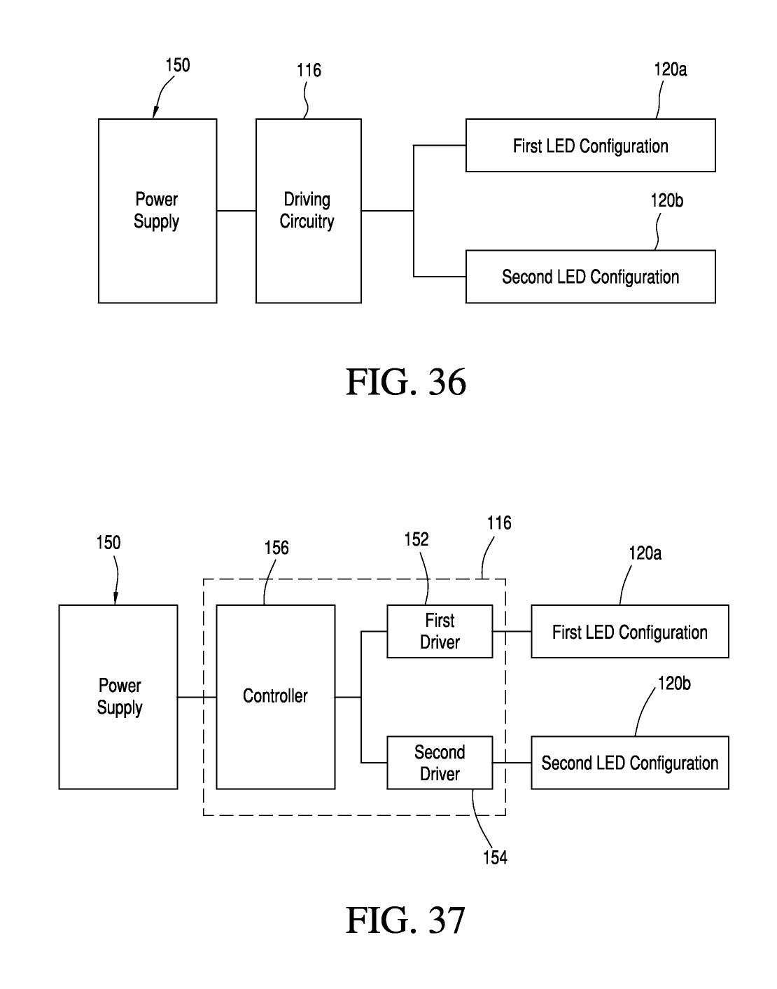

Turning now to FIGS. 36-40, another aspect of the disclosed technology will be described. In accordance with one exemplary embodiment, the light fixture can include multiple sets or configurations of LEDs. For example, the light fixture can include a first set or configuration of LEDs 120a and a second set or configuration of LEDs 120b along with power circuitry (also referred to as driving circuitry) 116 operatively coupled to the first set of LEDs 120a and the second set of LEDs 120b. The driving circuitry 116 can include an associated power supply (designated generally as 150), for example, a standard AC power supply found in a home or office setting. The driving circuitry 116 is configured to selectively power the first set of LEDs 120a and the second set of LEDs 120b.

In accordance with one embodiment (see FIG. 37), the power circuitry 116 can include a first driver 152 operatively coupled to the first LED configuration 120a and a second driver 154 operatively coupled to the second LED configuration 120b. The power circuitry 116 can include a controller 156 operatively coupled to the first driver 152 and the second driver 154, and configured to selectively operate the first driver 152 and the second driver 154 to control the first configuration of LEDs 120a and the second configuration of LEDs 120b in a desired manner.

In accordance with one embodiment, the first set or configuration of LEDs 120a and the second set or configuration of LEDs 120b are driven alternately. For example, while the first configuration of LEDs 120a is active, the second configuration of LEDs 120b can be set to inactive and vice versa. In a preferred embodiment, the first and second configurations of LEDs can be driven cyclically.

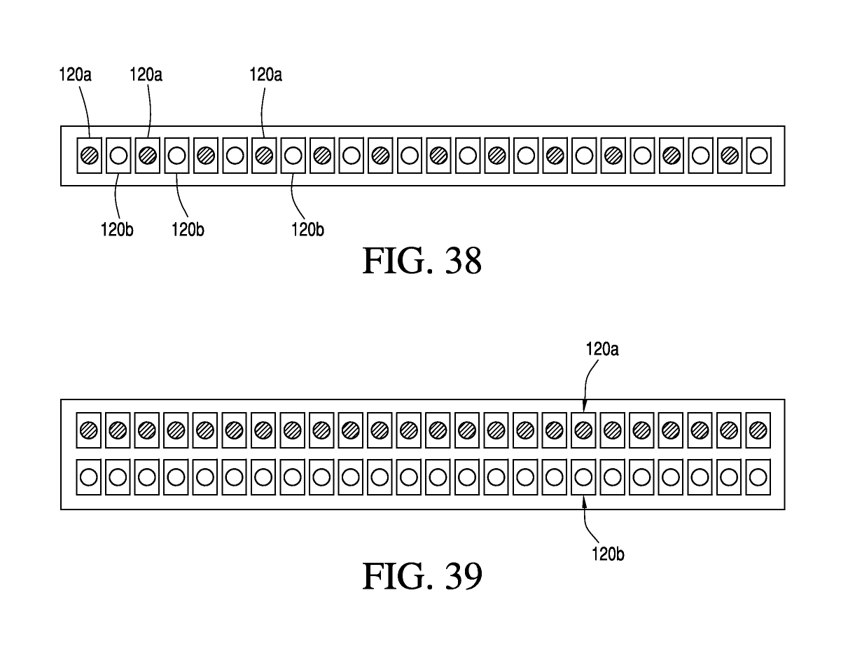

It will be appreciated that the first and second configurations of LEDs can be implemented in the lighting fixture in a number of ways without departing from the scope of the disclosed technology. For example, as shown in FIG. 38, the first configuration of LEDs 120a and the second configuration of LEDs 120b can be arranged in a single strip or bar in which a single row of LED elements are arrayed in an alternating arrangement (e.g., A B A B arrangement, where A corresponds to an LED within the first LED configuration 120a; and, B corresponds to an LED within the second LED configuration 120b).

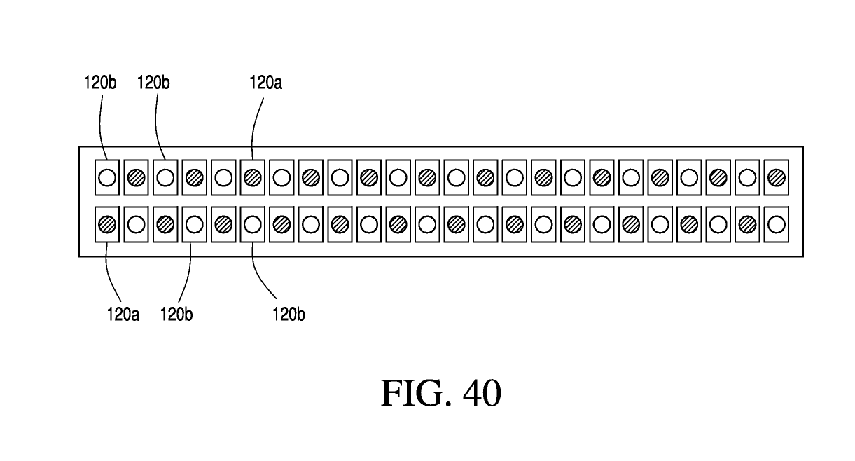

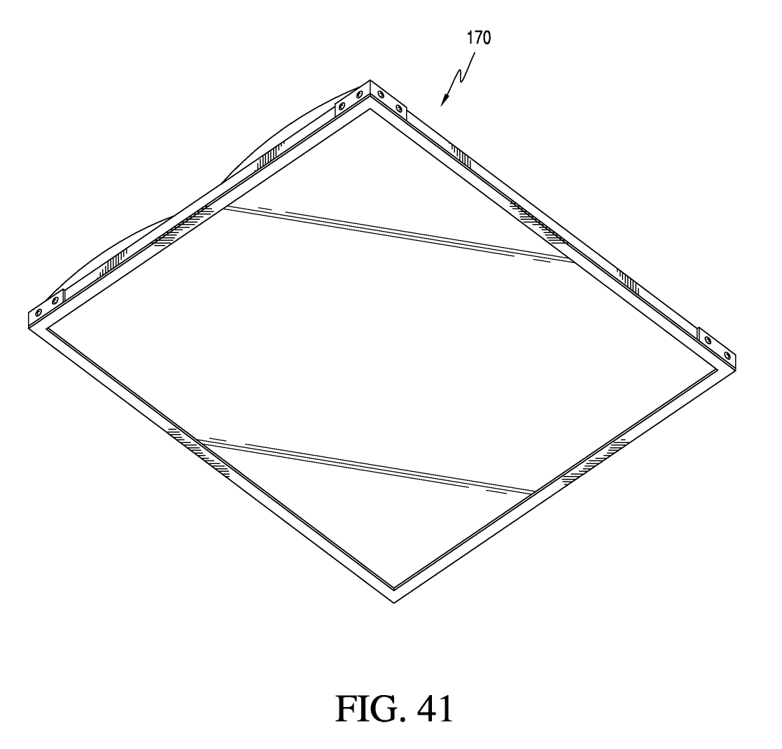

Alternatively, as shown in FIG. 39, the LEDs may be disposed in or otherwise arranged in a two-strip bar in which the first configuration of LEDs 120a is included along a top row and the second configuration of LEDs 120b is included along a bottom row. In yet another embodiment, as shown in FIG. 40, the LEDs can be arranged in a two-strip or two-row formation such that the first strip includes alternating arrangements of LEDs from the first configuration of LEDs 120a and the second configuration of LEDs 120b, and the second row of LEDs includes alternating arrangements from the first configuration of LEDs 120a and the second configuration of LEDs 120b. As the two rows of LEDs are located at different height differences between the LEDs and the crest of the reflector panel as discussed above, alternating the configurations 120a, 120b between these two rows may limit any difference in luminosity between the two configurations.

In accordance with one embodiment, the light fixture includes at least one mounting member configured to mount (e.g., removably or permanently mount) the frame to a support surface. It will be appreciated that the mounting member may take on numerous forms depending on the desired application. For example, the mounting member can be configured to mount the frame to a substantially vertical support surface, such as a wall. In this case, the mounting member may include suitable clips, brackets or the like configured to anchor the light fixture to a wall in a home, a wall in a hotel, a wall in a parking garage or the like. In another exemplary embodiment, the mounting member can be configured to mount the frame to a substantially horizontal support surface, such as a ceiling, the underside of a cabinet or the like. In a further embodiment, the light fixture can be configured to be installed in an inset lighting fixture such as a troffer.

It will be appreciated that the light fixture can be configured to be mechanically and electrically coupled to an external power supply such as an external junction box. Furthermore, the light fixture can be arranged and/or installed together with a plurality of light fixtures where a primary light fixture is electrically coupled to an external power supply and other light fixtures can be coupled to the external power supply by way of the primary light fixture (so called “daisy chaining”).

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A lamp illuminant structure having a lamp box provided with a reflection panel in the chamber of the lamp box; wherein the reflection panel is a wavy reflection plane including two troughs and one crest located between two troughs, and wherein two luminous bodies are respectively arranged adjacent to an internal wall of two sides of the chamber and respectively adjacent to the two troughs of the reflection panel; each of the two luminous bodies forming an angle from 0° to 90° with the chamber internal wall arranged as a perpendicular plane with the lamp box.

2. A lamp illuminant structure according to claim 1, wherein the two luminous bodies form an angle from 30° to 60° with the chamber internal wall arranged as a perpendicular plane with the lamp box.

3. A lamp illuminant structure according to claim 1, wherein a height difference between the luminous bodies and the crest of the reflection panel is from 0 to 10 mm.

4. A lamp illuminant structure according to claim 3, wherein a height difference between the luminous body and the crest of the reflection panel is 0 mm.

5. A lamp illuminant structure according to claim 1, wherein the chamber internal wall of the box is integrated with a slope for the arrangement of each of the luminous bodies thereon.

6. A lamp illuminant structure according to claim 5, wherein the slope forms an angle from 30° to 60° with the chamber internal wall arranged as a perpendicular plane with the lamp box.

7. A lamp illuminant structure according to claim 1, wherein the box is further provided with an optically-transmissive panel corresponding to a reflection plane of the reflection panel.

8. A lamp illuminant structure according to claim 7, wherein the optically-transmissive panel comprises a diffusing panel.

9. A lamp illuminant structure according to claim 7, wherein the optically-transmissive panel comprises a micro-lens diffuser panel.

10. A light fixture comprising:
a frame, the frame including a plurality of side walls;
an optically-transmissive panel coupled to the frame;
a light emitting diode (LED) array disposed adjacent at least one of the side walls; and
a waveform reflector plate coupled to the frame and positioned to receive light generated by the LED array and to reflect the light through the optically-transmissive panel.

11. The light fixture of claim 10, wherein the waveform reflector plate is configured to include a pair of troughs and a crest disposed between the troughs.

12. The light fixture of claim 11, wherein the crest is positioned at a distance of about 0 centimeters to about 5 centimeters from the optically-transmissive panel.

13. The light fixture of claim 11, wherein the crest is positioned at a distance of about 3 centimeters to about 10 centimeters from the optically-transmissive panel.

14. The light fixture of claim 10, wherein the frame includes a waveform cover coupled to the plurality of side walls.

15. The light fixture of claim 10, wherein the waveform reflector plate is coupled to a rigid supporting structure.

16. The light fixture of claim 10, wherein the optically-transmissive panel comprises a diffusing panel.

17. The light fixture of claim 10, wherein the optically-transmissive panel comprises a micro-lens diffuser plate.

18. The light fixture of claim 17, wherein the micro-lens diffuser plate includes a plurality of micro-lenses having a pitch of about 10 microns to about 100 microns.

19. The light fixture of claim 11, wherein the crest is positioned at a height of about 1 centimeter to about 10 centimeters relative to the troughs.

20. The light fixture of claim 11, wherein the crest is laterally spaced about 120 millimeters to about 160 millimeters from the troughs.

21. The light fixture of claim 10, wherein the waveform reflector plate includes a non-specular reflection surface.

22. The light fixture of claim 10, comprising a pair of LED arrays disposed adjacent opposite side walls of the frame.

23. The light fixture of claim 22, wherein each of the side walls of the frame is integrated with an inner support wall for the arrangement of the pair of LED arrays.

24. The light fixture of claim 10, wherein the frame has a length and a width at the plane perpendicular to the sides walls, and wherein the frame and the optically-transmissive panel cooperate to define a light-emission area of about 90% of the length by about 90% of the width.

25. The light fixture of claim 10, wherein the light fixture includes:
a first configuration of LEDs; and,
a second configuration of LEDs.

26. The light fixture of claim 25, wherein the power circuitry is configured to power the first configuration of LEDs for a first time period and to power the second configuration of LEDs for a second time period equal to the first time period.

27. The light fixture of claim 26, wherein the power circuitry is configured to alternatively power the first configuration of LEDs and the second configuration of LEDs over a cyclical time period including the first time period and the second time period.

28. The light fixture of claim 10, further comprising:
power circuitry disposed behind the waveform reflector plate, the power circuitry being configured to electrically couple the light emitting diode (LED) array to an external power supply.

29. The light fixture of claim 11, further comprising:
power circuitry disposed behind the crest of the waveform reflector plate, the power circuitry being configured to electrically couple the light emitting diode (LED) array to an external power supply.

30. The light fixture of claim 10, wherein the optically-transmissive panel is disposed in a plane perpendicular to the side walls.

31. The light fixture of claim 10, wherein the LED array is disposed at an angle of about 0° to 90° relative to the plane of the optically-transmissive panel.

32. The light fixture of claim 10, wherein the waveform reflector plate includes a non-specular reflection surface; and, wherein a portion of the waveform reflector plate adjacent the light emitting diode (LED) array includes a specular reflection surface.
